(19) United States
(12) Patent Application Publication
(10) Pub. No.: US 2025/0323975 A1
(43) Pub. Date: Oct. 16, 2025

(54) MEC FEDERATION BROKER AND MANAGER ENABLING SECURE CROSS-PLATFORM COMMUNICATION

(71) Applicant: Intel Corporation, Santa Clara, CA (US)

(72) Inventors: Miltiadis Filippou, München (DE); Dario Sabella, Gassino (IT)

(21) Appl. No.: 18/035,234

(22) PCT Filed: Dec. 6, 2021
(86) PCT No.: PCT/US2021/062038

§ 371 Date: May 3, 2023

Related U.S. Application Data
(60) Provisional application No. 63/122,263, filed on Dec. 7, 2020.

(51) Int. Cl. H04L 67/288; H04L 9/40

(52) U.S. Cl. CPC H04L 67/288; H04L 63/08

(57) ABSTRACT

Various systems and methods are described implementing a multi-access edge computing (MEC) based system to realize MEC federation management and broker functions for MEC frameworks. In an example, performing edge federation management functions of edge computing systems, to establish a partnership among multiple edge federation managers as a federation, include: using system data attributes to establish the partnership; using authentication data attributes to enable the edge federation managers to securely authenticate; using authorization data attributes to enable the edge federation managers to perform authorization; using availability zone data attributes to define zones in the federation; and using management and settlement information data attributes to enable management of resources in the federation. Further operations include communicating the data attributes via respective connections with the edge federation managers, and the use of defined interfaces and operations.

### PRIORITY CLAIM

This application claims the benefit of priority to: U.S. Provisional Patent Application No. 63/122,263, filed Dec. 7, 2020, which is incorporated by reference herein in its entirety.

### TECHNICAL FIELD

Embodiments described herein generally relate to data processing, network communication, and communication system implementations, and in particular, to techniques implemented in a federated multi-access edge computing (MEC) framework.

### BACKGROUND

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

Edge computing use cases in mobile network settings have been developed for integration with MEC approaches, also known as “mobile edge computing.” MEC approaches are designed to allow application developers and content providers to access computing capabilities and an information technology (IT) service environment in dynamic mobile network settings at the edge of the network. Limited standards have been developed by the European Telecommunications Standards Institute (ETSI) industry specification group (ISG) in an attempt to define common interfaces for the operation of MEC systems, platforms, hosts, services, and applications.

Edge computing, MEC, and related technologies attempt to provide reduced latency, increased responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (devices, hosts, tenants, service providers, operators) are involved.

Similarly, Internet of Things (IoT) networks and devices are designed to offer a distributed compute arrangement, from a variety of endpoints. IoT devices are physical or virtualized objects that may communicate on a network and may include sensors, actuators, and other input/output components, which may be used to collect data or perform actions in a real-world environment. For example, IoT devices may include low-powered endpoint devices that are embedded or attached to everyday things, such as buildings, vehicles, packages, etc., to provide an additional level of artificial sensory perception of those things. Recently, IoT devices have become more popular and thus applications using these devices have proliferated.

The deployment of various Edge, Fog, MEC, private enterprise networks (e.g., software-defined wide-area networks, or SD-WANs), and IoT networks, devices, and services have introduced a number of advanced use cases and scenarios occurring at and towards the edge of the network. However, these advanced use cases have also introduced a number of corresponding technical challenges relating to security, processing, and network resources, service availability, and efficiency, among many other issues. One such technical challenge is concerning trust and security among the various entities of a MEC federation. In this regard, an improvement of the trust among the various operating partners (e.g., mobile network operators, edge service providers, etc.). is needed ensure proper collaboration in the MEC federation.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing, according to an example;

FIG. 2 illustrates deployment and orchestration for virtual edge configurations across an edge-computing system operated among multiple edge nodes and multiple tenants, according to an example;

FIG. 3 illustrates a vehicle compute and communication use case involving mobile access to applications in an edge-computing system, according to an example;

FIG. 4 illustrates a block diagram depicting deployment and

communications among several Internet of Things (IoT) devices, according to an example;

FIG. 5 illustrates a block diagram for a Multi-access Edge Computing (MEC) system architecture, according to an example;

FIG. 6A illustrates a MEC reference architecture enhanced with federation broker and management entities, according to an example;

FIG. 6B illustrates a MEC reference architecture in a multi-system setting enhanced with federation broker and management entities, according to an example;

FIG. 6C illustrates a MEC reference architecture in a multi-system setting enhanced with federation broker and management entities incorporated into a MEC federator entity, according to an example;

FIG. 7 illustrates an overview of layers of distributed compute deployed among an edge computing system, according to an example;

FIG. 8 illustrates an overview of example components deployed at a compute node system, according to an example;

FIG. 9 illustrates a further overview of example components within a computing device, according to an example;

FIG. 10 illustrates a software distribution platform to distribute software instructions and derivatives, according to an example;

FIG. 11 illustrates an overview of a framework, establishing connections between Federation Managers and a Federation Broker in a MEC Federation, according to an example;

FIG. 12 illustrates a connections among Federation Managers and a Broker in a MEC Federation, according to an example;

FIG. 13 illustrates an implementation of Regions in a MEC Federation, according to an example;

FIG. 14 illustrates a hierarchical deployment of Brokers and Managers in multiple regions of a MEC Federation, according to an example;

FIG. 15 illustrates topology options for connecting brokers across regions in a global MEC Federation, according to an example;

FIG. 16 illustrates a flow of a Multi-access Edge Federation Broker (MEFB) and a Multi-access Edge Federation Manager (MEFM) of a MEC Federation receiving Federation Management Information (FMI) event notifications, according to an example;

FIG. 17 illustrates an attestation augmented authentication procedure in a MEC Federation involving two MEFB entities, according to an example;

FIG. 18 illustrates a MEC Federation level architecture adapted for security assessment via attestation, according to an example;

FIG. 19 illustrates a MEC Platform level architecture adapted for security assessment via attestation, according to an example; and

FIG. 20 illustrates a flowchart of a method for performing edge federation management functions, according to an example.

### DETAILED DESCRIPTION

In the following description, methods, configurations, and related apparatuses are disclosed for providing a MEC Federator, including features of a federation Broker and Manager, configured for enabling secure cross-platform communication in a network (such as a telecommunications service provider (telco) edge cloud). The following examples introduce specific configurations and usage of a framework for a MEC federation (e.g., a MEC-based network including multiple MEC systems forming a MEC federation), including (i) the specification of new MEC Federation Manager and MEC Federation Broker, in separate entities and as a combined MEC Federator and (ii) the definition of the East-Westbound Interface (EWBI) of a MEC Federation including the involved information flows, required information, and operations.

Among other topics, the following discusses adaptation of a typical MEC Federation scenario, as described in GSMA Operator Platform (OP) and enabled by ETSI MEC standards. For example, the following addresses: How to improve the level of trust of OP partners in a MEC Federation needed to foster further collaboration with multiple partners (e.g., between mobile network operators (MNOs) and Hyperscalers), and enhance the overall portfolio of offerings for the customer; and How to improve the bilateral trust among the OP partners needed to ensure a fair shared use of commonly accessible resources via predefined OP partners agreements, including charging/billing principles among them and toward the customers.

In the following, a MEC Federation framework is proposed which includes three technology changes to a MEC architecture:

1) Definition of a MEC Federation Manager and MEC Federation Broker functional entities (which may be implemented as one or two entities, and are jointly referred to as “MEFM/B”) (to be introduced as new standard entities in the ETSI MEC architecture) permitting the exchange, storing and processing of information to be standardized in the EWBI interface of a MEC federation.

2) Definition of the required information elements forming data models aimed to be exchanged in a standardized manner via the EWBI interface of a MEC Federation inter-connecting different ETSI MEC systems. More specifically, the following defines new reference points in ETSI MEC reference architecture needed to interconnect the new functional entities of the ETSI MEC architecture with one another and with existent ones.

3) Design of an information exchange as a top-down approach ensuring trust and security-native MEC Federation operation exploiting attestation, that includes many types of exposed/consumed resources. These resources refer to not only edge cloud hardware and software, but also include specific compute components, and also software instances e.g., toolkits, or other MEC apps, etc.

### Applicability of MEC Federation Communication and Management Techniques

The present MEC federation communication and management techniques may be coordinated and monitored in a variety of device and computing system deployment environments involving the edge computing/edge cloud deployments, cloud deployments, Internet of Things (IoT) networks, Multi-Access Edge Computing (MEC) systems including MEC-based automotive deployments, edge workloads such as network function virtualization (NFV) implementations or other virtualized node functions, and other aspects of networking technologies.

The present MEC Federation communication and management techniques and configurations may be utilized in connection with many aspects of current networking systems, but are provided regarding Edge Cloud, IoT, MEC, and other distributed computing deployments including automotive deployments. The following systems and techniques may be implemented in, or augment, a variety of distributed, virtualized, or managed edge computing systems. These include environments in which network services are implemented or managed using multi-access edge computing (MEC) or 4G/5G wireless network configurations; or in wired network configurations involving fiber, copper, and other connections. Further, aspects of processing by the respective computing components may involve computational elements that are in the geographical proximity of user equipment or other endpoint locations, such as a smartphone, vehicular communication component, IoT device, etc. Further, the presently disclosed techniques may relate to other Edge/MEC/IoT network communication standards and configurations, and other intermediate processing entities and architectures.

The present MEC Federation communication and management techniques and configurations facilitate the establishment of MEC federation enabling secure communication among the OP partners. Such a development enables and supports new business and market deployments with regards to MEC and cloud computing technology. More particularly, the framework addresses the needs of the entire ecosystem of computing (from MNOs to Edge Cloud vendors, to Infrastructure providers, etc.

### Example Edge Computing Architectures

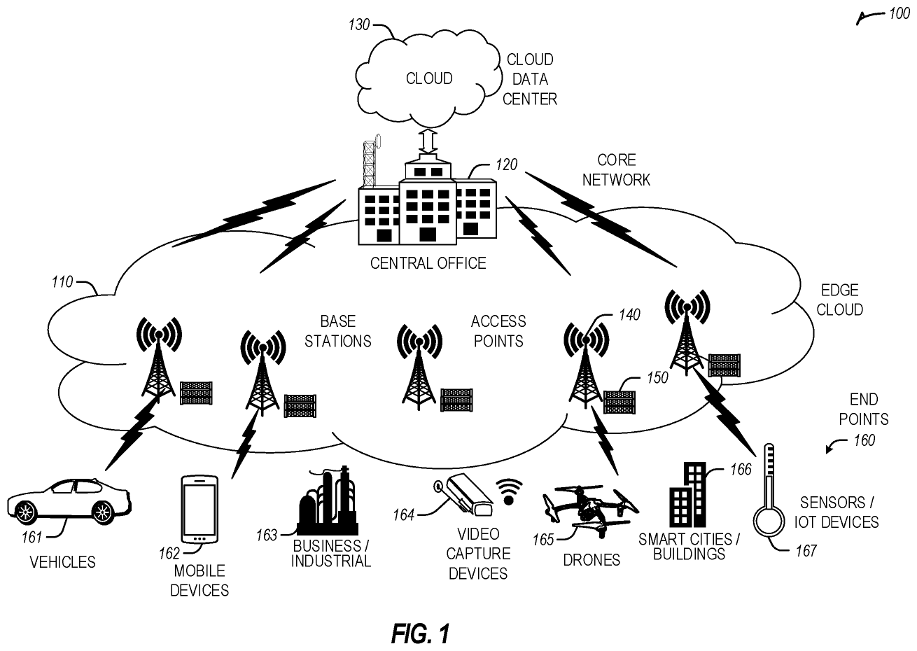

FIG. 1 is a block diagram 100 showing an overview of a configuration for edge computing, which includes a layer of processing referenced in many of the current examples as an “edge cloud”. This network topology, which may include a number of conventional networking layers (including those not shown herein), may be extended through the use of the MEC Federation and MEC System interconnection discussed herein.

As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle. These and other scenarios may involve the use of MEC federation, as provided in the discussion below.

In contrast to the network architecture of FIG. 1, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data-center.

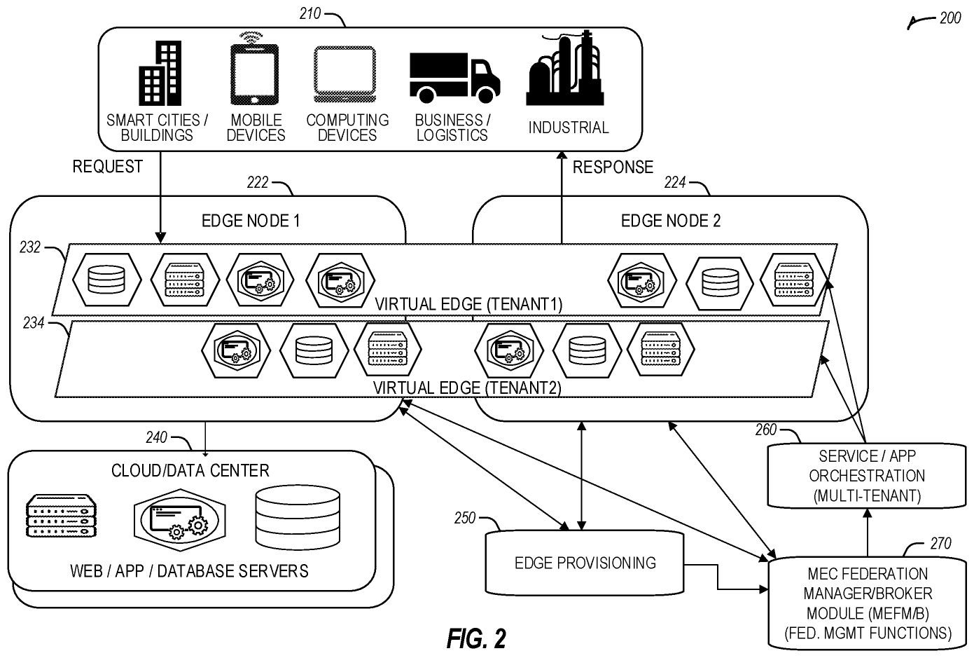

FIG. 2 illustrates deployment and orchestration for virtual edge configurations across an edge computing system operated among multiple edge nodes and multiple tenants. Specifically, FIG. 2 depicts coordination of a first edge node 222 and a second edge node 224 in an edge computing system 200, to fulfill requests and responses for various client endpoints 210 (e.g., smart cities/building systems, mobile devices, computing devices, business/logistics systems, industrial systems, etc.), which access various virtual edge instances. The virtual edge instances 232, 234 (or virtual edges) provide edge compute capabilities and processing in an edge cloud, with access to a cloud/data center 240 for higher-latency requests for websites, applications, database servers, etc. Thus, the edge cloud enables coordination of processing among multiple edge nodes for multiple tenants or entities.

In the example of FIG. 2, these virtual edge instances include a first virtual edge 232, offered to a first tenant (Tenant 1), which offers a first combination of edge storage, computing, and services; and a second virtual edge 234, offering a second combination of edge storage, computing, and services, to a second tenant (Tenant 2). The virtual edge instances 232, 234 are distributed among the edge nodes 222, 224, and may include scenarios in which a request and response are fulfilled from the same or different edge nodes. The configuration of each edge node 222, 224 to operate in a distributed yet coordinated fashion occurs based on edge provisioning functions 250. The functionality of the edge nodes 222, 224 to provide coordinated operation for applications and services, among multiple tenants, occurs based on orchestration functions 260.

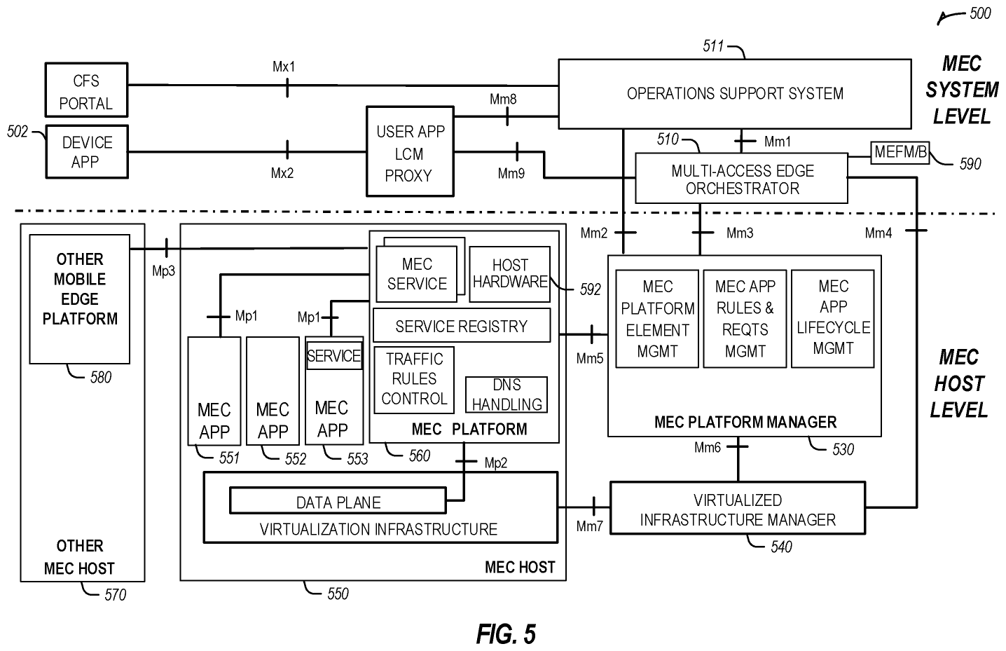

The Multi-access edge Federation Manager and Broker (MEFM/B) 270 can be used to configure and perform federation management and broker functions within a communication network, including a federated MEC framework including multiple MEC systems (e.g., as discussed in connection with FIGS. 5-6C and FIGS. 11-20). For example, as a service is provided in a MEC framework and network (e.g., among the edge nodes 222, 224), the MEFM/B 270 may coordinate MEC federation and MEC operations. More details on federation management functions discussed in connection with FIGS. 5-6C and FIGS. 11-20.

It should be understood that some of the devices in 210 are multi-tenant devices where Tenant1 may function within a Tenant1 ‘slice’ while a Tenant2 may function within a Tenant2 ‘slice’ (and, in further examples, additional or sub-tenants may exist; and each tenant may even be specifically entitled and transactionally tied to a specific set of features all the way to specific hardware features). A trusted multi-tenant device may further contain a tenant-specific cryptographic key such that the combination of a key and a slice may be considered a “root of trust” (ROT) or tenant-specific RoT. A ROT may further be computed dynamically composed using a security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The ROT also may be used for a trusted computing context to support respective tenant operations, etc. Use of this ROT and the security architecture may be enhanced by the attestation operations further discussed herein.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning devices in 210, 222, and 240 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other security functions related to the provisioning and lifecycle of the trusted ‘slice’ concept in FIG. 2. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or, respective computing systems and resources which are co-owned or co-managed by multiple owners).

For instance, each edge node 222, 224 may implement the use of containers, such as with the use of a container “pod” 226, 228 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 232, 234 are partitioned according to the needs of each container.

With the use of container pods, a pod controller oversees the partitioning and allocation of containers and resources. The pod controller receives instructions from an orchestrator (e.g., performing orchestration functions 260) that instructs the controller on how best to partition physical resources and for what duration, such as by receiving key performance indicator (KPI) targets based on SLA contracts. The pod controller determines which container requires which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents the assignment of resources until the right tenant authenticates or prevents provisioning of data or a workload to a container until an attestation result is satisfied.

Also, with the use of container pods, tenant boundaries can still exist but in the context of each pod of containers. If each tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestrator 260 may provision an attestation verification policy to local pod controllers that perform attestation verification. If an attestation satisfies a policy for a first tenant pod controller but not a second tenant pod controller, then the second pod may be migrated to a different edge node that does satisfy it. Alternatively, the first pod may be allowed to execute and a different shared pod controller is installed and invoked before the second pod executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to each tenant (aside from the execution of virtualized network functions).

Within the edge cloud, a first edge node 222 (e.g., operated by a first owner) and a second edge node 224 (e.g., operated by a second owner) may operate or respond to a container orchestrator to coordinate the execution of various applications within the virtual edge instances offered for respective tenants. For instance, the edge nodes 222, 224 may be coordinated based on edge provisioning functions 250, while the operation of the various applications is coordinated with orchestration functions 260.

Various system arrangements may provide an architecture that treats VMs, Containers, and Functions equally in terms of application composition (and resulting applications are combinations of these three ingredients). Each ingredient may involve the use of one or more accelerator (e.g., FPGA, ASIC) components as a local backend. In this manner, applications can be split across multiple edge owners, coordinated by an orchestrator.

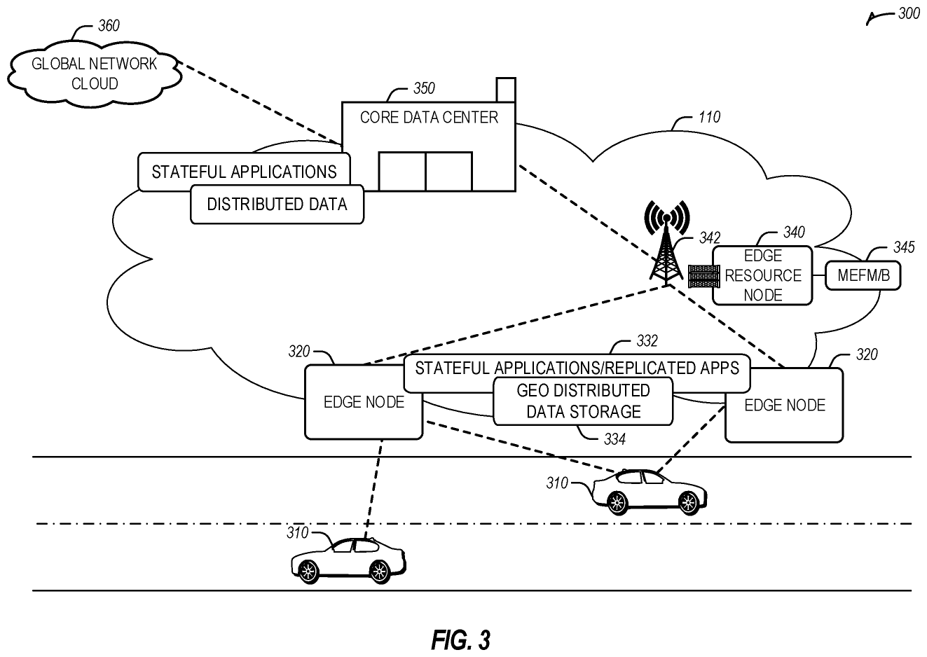

It should be appreciated that the edge computing systems and arrangements discussed herein may be applicable in various solutions, services, and/or use cases. As an example, FIG. 3 shows a simplified vehicle compute and communication use case involving mobile access to applications in an edge computing system 300 that implements an edge cloud 110 and an MEFM/B 345 (which can be the same as the federation manager and broker entity/entities discussed in connection with FIGS. 5-6C and FIGS. 11-20). In this use case, each client compute node 310 may be embodied as in-vehicle compute systems (e.g., in-vehicle navigation and/or infotainment systems) located in corresponding vehicles that communicate with the edge gateway nodes 320 during traversal of a roadway. For instance, edge gateway nodes 320 may be located in roadside cabinets, which may be placed along the roadway, at intersections of the roadway, or other locations near the roadway. As each vehicle traverses along the roadway, the connection between its client compute node 310 and a particular edge gateway node 320 may propagate to maintain a consistent connection and context for the client compute node 310. Each of the edge gateway nodes 320 includes some processing and storage capabilities and, as such, some processing and/or storage of data for the client compute nodes 310 may be performed on one or more of the edge gateway nodes 320.

Each of the edge gateway nodes 320 may communicate with one or more edge resource nodes 340, which are illustratively embodied as compute servers, appliances or components located at or in a communication base station 342 (e.g., a base station of a cellular network). As discussed above, each edge resource node 340 includes some processing and storage capabilities, and, as such, some processing and/or storage of data for the client compute nodes 310 may be performed on the edge resource node 340. For example, the processing of data that is less urgent or important may be performed by the edge resource node 340, while the processing of data that is of a higher urgency or importance may be performed by edge gateway devices or the client nodes themselves (depending on, for example, the capabilities of each component). Further, various wired or wireless communication links (e.g., fiber optic wired backhaul, 5G wireless links) may exist among the edge nodes 320, edge resource node(s) 340, core data center 350, and network cloud 360.

The edge resource nodes 340 (or any other edge nodes within the edge computing system 300) may further include an MEFM/B 345 configured to perform federation management and broker functions within a communication network, such as an edge computing system 300 implementing a MEC federation. For example, as a service or apps is provided in a MEC framework and network (e.g., among the edge nodes 340 or 320), the MEFM/B 270 may coordinate MEC federation and MEC operations. Various federation management functions are also discussed in connection with FIGS. 5-6C and FIGS. 11-20.

The edge resource node(s) 340 also communicate with the core data center 350, which may include compute servers, appliances, and/or other components located in a central location (e.g., a central office of a cellular communication network). The core data center 350 may provide a gateway to the global network cloud 360 (e.g., the Internet) for the edge cloud 110 operations formed by the edge resource node(s) 340 and the edge gateway nodes 320. Additionally, in some examples, the core data center 350 may include an amount of processing and storage capabilities and, as such, some processing and/or storage of data for the client compute devices may be performed on the core data center 350 (e.g., processing of low urgency or importance, or high complexity). The edge gateway nodes 320 or the edge resource nodes 340 may offer the use of stateful applications 332 and a geographically distributed data storage 334 (e.g., database, data store, etc.).

In further examples, FIG. 3 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 320, some others at the edge resource node 340, and others in the core data center 350 or the global network cloud 360.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

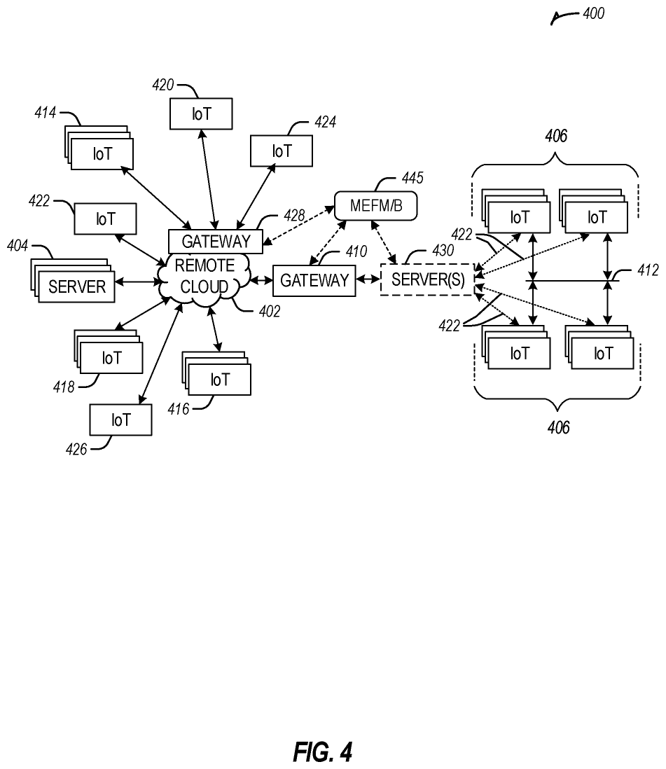

As a more detailed illustration of an Internet of Things (IoT) network, FIG. 4 illustrates a drawing of a cloud or edge computing network 400, in communication with several IoT devices and an MEFM/B 445. The IoT is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 4, the network 400 may represent portions of the Internet or may include portions of a local area network (LAN), or a wide area network (WAN), such as a proprietary network for a company. The IoT devices may include any number of different types of devices, grouped in various combinations. For example, a traffic control group 406 may include IoT devices along streets in a city. These IoT devices may include stoplights, traffic flow monitors, cameras, weather sensors, and the like. The traffic control group 406, or other subgroups, may be in communication within the network 400 through wired or wireless links 408, such as LPWA links, optical links, and the like. Further, a wired or wireless sub-network 412 may allow the IoT devices to communicate with each other, such as through a local area network, a wireless local area network, and the like. The IoT devices may use another device, such as a gateway 410 or 428 to communicate with remote locations such as remote cloud 402; the IoT devices may also use one or more servers 430 to facilitate communication within the network 400 or with the gateway 410. For example, the one or more servers 430 may operate as an intermediate network node to support a local edge cloud or fog implementation among a local area network. Further, the gateway 428 that is depicted may operate in a cloud-to-gateway-to-many edge devices configuration, such as with the various IoT devices 414, 420, 424 being constrained or dynamic to an assignment and use of resources in the network 400.

In an example embodiment, the network 400 can further include an MEFM/B 445 configured to perform federation management and broker functions within the network 400. For example, as a service is provided in a MEC framework and network within systems in the network 400, the MEFM/B 445 may coordinate MEC federation and MEC system operations. Other federation management functions are also discussed in connection with FIGS. 5-6C and FIGS. 11-20.

Other example groups of IoT devices may include remote weather stations 414, local information terminals 416, alarm systems 418, automated teller machines 420, alarm panels 422, or moving vehicles, such as emergency vehicles 424 or other vehicles 426, among many others. Each of these IoT devices may be in communication with other IoT devices, with servers 404, with another IoT device or system, another edge computing or “fog” computing system, or a combination therein. The groups of IoT devices may be deployed in various residential, commercial, and industrial settings (including in both private or public environments).

As may be seen from FIG. 4, a large number of IoT devices may be communicating through the network 400. This may allow different IoT devices to request or provide information to other devices autonomously. For example, a group of IoT devices (e.g., the traffic control group 406) may request a current weather forecast from a group of remote weather stations 414, which may provide the forecast without human intervention. Further, an emergency vehicle 424 may be alerted by an automated teller machine 420 that a burglary is in progress. As the emergency vehicle 424 proceeds towards the automated teller machine 420, it may access the traffic control group 406 to request clearance to the location, for example, by lights turning red to block cross traffic at an intersection in sufficient time for the emergency vehicle 424 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 414 or the traffic control group 406, may be equipped to communicate with other IoT devices as well as with the network 400. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an IPV6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, a LPWA link, or a link based on the IEEE 802.15.4 standard, such as ZigbeeR. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QOS) based swarming and fusion of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource-based trust and service indices may be inserted to improve the data integrity, quality, assurance, and deliver a metric of data confidence.

An IoT network, arranged as a WLAN network, for instance, may use systems that perform standards conversion to provide multi-standard connectivity, enabling IoT devices to use different protocols to communicate. Further systems may provide seamless interconnectivity across a multi-standard infrastructure comprising visible Internet resources and hidden Internet resources.

An IoT network, using communications in the cellular network, for instance, may be enhanced by systems that offload data, extend communications to more remote devices, or both. A LPWA network may include systems that perform non-Internet protocol (IP) to IP interconnections, addressing, and routing. Further, each of the IoT devices may include the appropriate transceiver for wide-area communications with that device. Further, each IoT device may include other transceivers for communications using additional protocols and frequencies.

In further examples, an edge or cloud computing network may be in communication with a mesh network of IoT devices at the edge of the cloud computing network. The mesh network of IoT devices may be termed a fog device or system, operating at the edge of the cloud. This fog device or system may be a massively interconnected network where several IoT devices are in communications with each other by radio links, for example. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

These and other examples of IoT networks may be enhanced with the following uses of MEC federation functionalities using the MEFM/B 445 as discussed in connection with FIGS. 5-6C and FIGS. 11-20.

### Example MEC Architectures

Some of the techniques and configurations discussed concerning MEC may be (but are not required to be) relevant to the standards and approaches published in ETSI GS MEC 003 “Mobile Edge Computing (MEC); Framework and Reference Architecture” (e.g., versions 2 or 3, and onwards) and related MEC or networked operational implementations (e.g., ETSI GS MEC 030; “Multi-access Edge Computing (MEC); V2X Information Service API”, versions 2 or 3, and onwards; ETSI GR MEC 035: “Multi-access Edge Computing (MEC); Study on Inter-MEC systems and MEC-Cloud systems coordination”, versions 2 or 3, and onwards). However, while the present resource management techniques and configurations may provide significant benefits to MEC architectures, the applicability of the present techniques and configurations may be extended to any number of edge computing, IoT, fog, or distributed computing platforms.

MEC is intended to support developing mobile use cases of edge computing, to allow application developers and content providers to access computing capabilities and an IT service environment in dynamic settings at the edge of the network. MEC offers application developers and content providers cloud-computing capabilities and an IT service environment using equipment located closer to network (e.g., cellular network) edges. This environment is characterized by ultra-low latency and high bandwidth as well as real-time access to radio network information that may be leveraged by applications. MEC technology permits operators to flexibly and rapidly deploy innovative applications and services towards mobile subscribers, enterprises, and vertical segments.

MEC, like other edge computing deployments, may reduce network congestion by operating applications, data functions, and discovery, etc. closer to the user (e.g., mobile device, user equipment (UE), station (STA), etc.). Some MEC details dealing with security (e.g., both user security as well as application integrity), radio use, etc., have been promulgated by European Telecommunications Standards Institute (ETSI), such as described in the “Mobile Edge Computing Introductory Technical White Paper,” published Sep. 1, 2014. A set of specifications and white papers providing further details and implementation use cases for MEC scenarios is being developed and published on an ongoing basis by ETSI as part of the ETSI MEC industry specification group (ISG).

MEC architectures offer application developers and content providers cloud-computing capabilities and an IT service environment at the edge of the network. This environment is characterized by ultra-low latency and high bandwidth as well as real-time access to radio network information that can be leveraged by applications. MEC technology thus permits flexible and rapid deployment of innovative applications and services towards mobile subscribers, enterprises, and vertical segments. For instance, in automotive settings, applications such as V2X (vehicle-to-everything, IEEE 802.11p based or 3GPP LTE-V2X based) may use MEC technology to exchange data, provide data to aggregation points, and access data in databases to provide and obtain an overview of the local situation derived from a multitude of sensors (by various cars, roadside units, etc.).

FIG. 5 depicts a block diagram for example Multi-access Edge Computing (MEC) system architecture 500. In an example, the MEC system architecture 500 may be defined according to a specification, standard, or other definition (e.g., according to the ETSI ISG MEC 003 specification). In this diagram, Mp reference points refer to MEC platform functionality, Mm reference points refer to management, and Mx refers to connections to external entities. The services, applications, orchestrators, and other entities discussed herein may be implemented at any number of the entities of the MEC system architecture depicted in FIG. 5, and the communications to perform network operations may be implemented at any number of the interfaces of the MEC system architecture depicted in FIG. 5.

For instance, a device application 502 operating at a client user equipment device (e.g., smartphone) may access a multi-access edge orchestrator 510, to obtain SLA information from an orchestrator. A MEC Host 550 may operate one or more MEC applications 551, 552, 553, or a platform 560 using host hardware 592 (including one or more shared memory regions).

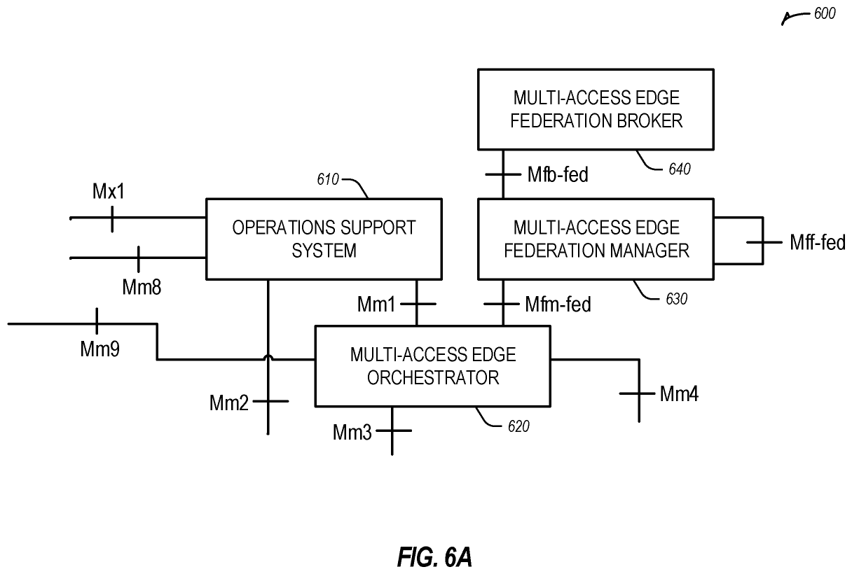

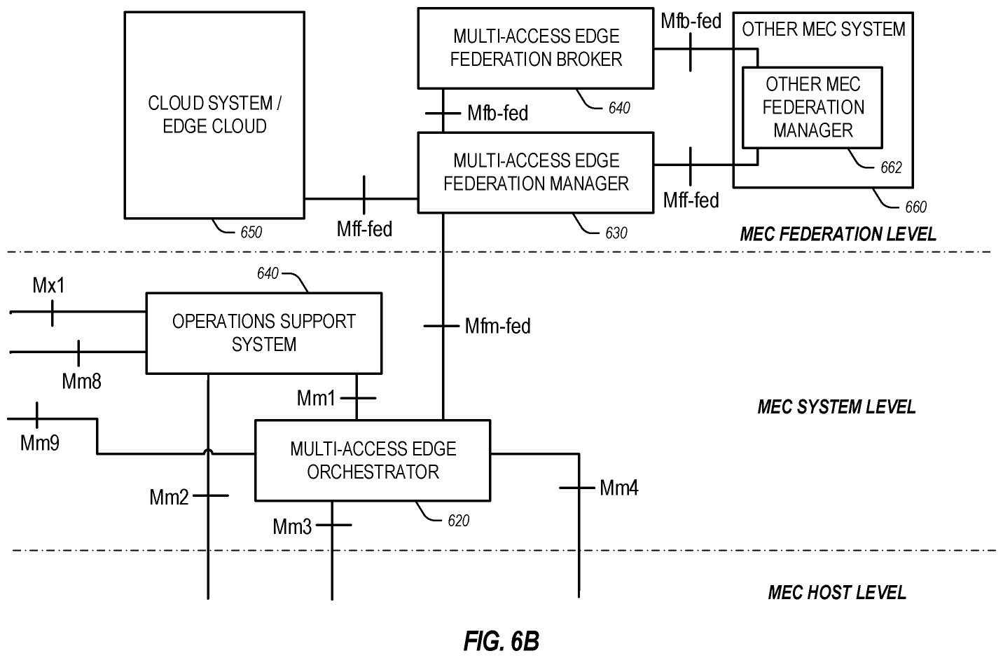

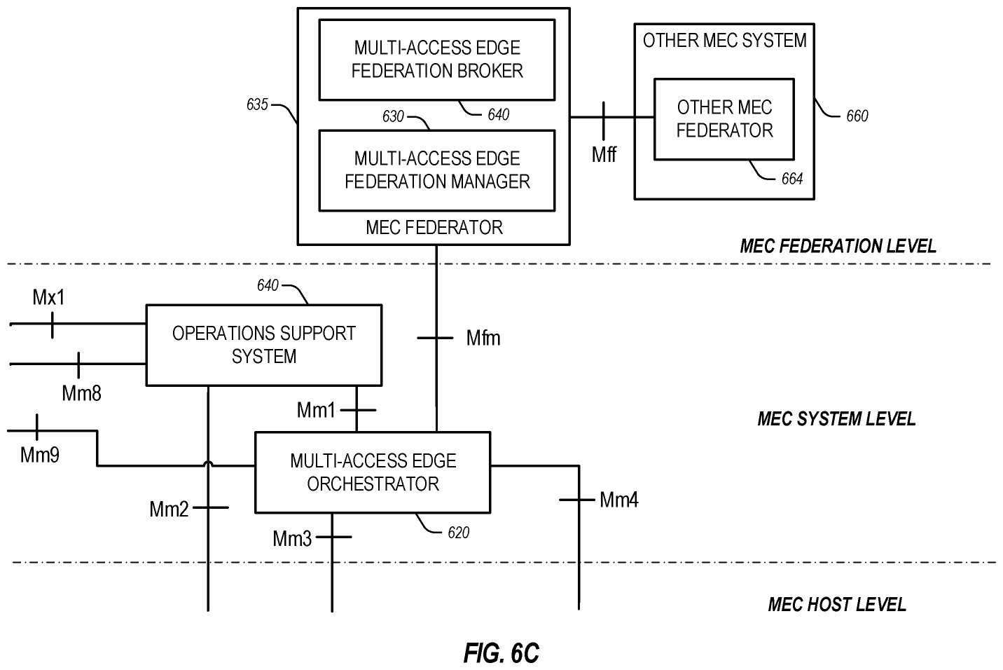

In some aspects, the MEC system architecture 500 may use MEFM/B 590 to configure and manage a framework to realize a MEC federation constituting of MEC systems, possibly owned and operated by different parties (e.g., MNOs). This signaling framework can be configured to refer to the following hierarchical inter-MEC system communication levels: (a) MEC system (i.e., below business level) discovery, including security (authentication/authorization, system topology hiding/encryption), charging, identity management and monitoring aspects as an essential prerequisite to forming a MEC federation; (b) MEC platform discovery, either at high granularity (i.e., MEC platform) or, low granularity (e.g., zone, zone group, Network functions virtualization infrastructure (NFVI) Point-of-Presence, NFVI node if a needed service is deployed as a virtual network function (VNF)); and (c) Information exchange at MEC platform level, for the needs of MEC service consumption, or MEC app-to-app communication. Other federation management functions are also discussed in connection with FIGS. 6A-6C and FIGS. 11-19.

In an example, the MEFM/B 590 may be configured within the MEC platform 560 of a MEC host (e.g., MEC Host 550). In other examples, the MEFM/B 590 may be configured within the MEC platform manager 530, or as a stand-alone implementation within a network node (e.g., a node coupled to the Multi-access Edge Orchestrator (MEO) 510 and the Operations Support System (OSS) 511.

ETSI GS MEC 003 (on the MEC reference architecture) provides a framework and reference architecture for MEC, however, focusing on a single MEC system, therefore, not directly supporting MEC Federations. Two functional entities referring to MEC system-level management are the Operations Support System (OSS) and the Multi-access edge orchestrator (MEO), which are specified as per the following excerpts:
Operations Support System (OSS): “The Operations Support System (OSS) in FIG. 6-1 [of GS MEC 003] refers to the OSS of an operator. It receives requests via the CFS portal and from device applications for instantiation or termination of applications, and decides on the granting of these requests. Granted requests are forwarded to the multi-access edge orchestrator for further processing. When supported, the OSS also receives requests from device applications for relocating applications between external clouds and the MEC system”.
Multi-access edge orchestrator (MEO): “The multi-access edge orchestrator is the core functionality in MEC system level management. The multi-access edge orchestrator is responsible for the following functions: i) maintaining an overall view of the MEC system based on deployed MEC hosts, available resources, available MEC services, and topology; ii) on-boarding of application packages, including checking the integrity and authenticity of the packages, validating application rules and requirements and if necessary adjusting them to comply with operator policies, keeping a record of on-boarded packages, and preparing the virtualization infrastructure manager(s) to handle the applications; iii) selecting appropriate MEC host(s) for application instantiation based on constraints, such as latency, available resources, and available services; iv) triggering application instantiation and termination; and v) triggering application relocation as needed when supported.”

From the above excerpts, it is clear that the concept of a MEC federation consisting of multiple MEC systems cannot be realized by means of the current MEC reference architecture. Of course, clause 9 of the MEC 003 GS introduces the concept of inter-MEC system communication, however, only high-level requirements are expressed along with a high-level description of a hierarchical framework for inter-MEC system discovery and communication.

ETSI MEC work item MEC 035 is a study on Inter-MEC systems and MEC-Cloud systems coordination. The (draft) GR MEC 035 document provides the following excerpt: “The present document studies the applicability of MEC specifications to inter-MEC systems and MEC-Cloud systems coordination that supports e.g., application instance relocation, synchronization, and similar functionalities. Another subject of this study is the enablement and/or enhancement of functionalities for application lifecycle management by third parties (e.g. application developers). Firstly, the study analyses the current specifications. Secondly, the study documents the use cases that require inter-system coordination, including those in multi-MNO environments. Thirdly, the study clarifies the requirements and any missing parts. Finally, the study indicates possible solutions to close the gaps. The document considers the relevant work of other industry bodies relating to inter system coordination and all relevant work done in ETSI.”

In drafts of ETSI GR MEC 035, a MEC federation is defined as follows: “MEC federation: a federated model of MEC systems enabling shared usage of MEC services and applications”. In Clause 6 of ETSI GR MEC 035 drafts, high level definitions of the Federation Manager and Federation Broker entities are provided, however, lacking specific details regarding the duties and operation of these entities. Excerpts from this draft include the following:

Federation Manager: “The Federation Manager is located in the MEC system level and connected to MEO depicted in FIG. 6.2.1. The new reference points can [be] proposed. The first one, Mff-fed is for connecting between Federation Managers of different MEC systems and the second one, Mfm-fed, is connecting with its own MEO and delivering requests from other Federation Managers. The Federation Manager is mainly responsible for supporting inter-MEC system communication with these following functionalities:
Authorization, authentication and control access for MEC federation members;
Security, flow control and topology/identity hiding/encryption; ·Application life cycle management (e.g., forwarding instantiation/termination request);
Resources/platform publishing and discovery; ·Exposure of the catalog of MEC systems; ·Publishing and discovering dealing all assurance functionalities (charging, monitoring, etc.);”

Federation Broker: “We consider primarily a Federation Manager entity for each MEC system with P2P agreements between them. Nevertheless, as an alternative option, also a Federation Broker could be considered in order to reduce complexity to reach a high number of federation agreements, as illustrated in FIG. 6.2.2. The present solution proposal is applicable to both variants. In case of considering a Federation Broker, a new reference point between a Federation Manager and Federation Broker, Mfb-fed, can be considered.”

In the above excerpts it is evident that, although the functional entities of a Federation Manager and a Federation Broker—along with the involved reference points (Mfm-fed, Mff-fed, Mfb-fed)—have been introduced in the MEC 035 study, the descriptions are quite high level, thus, lacking details and clarity on how these blocks should be implemented and how the communication should be defined. With respect to the three mentioned reference points, the GR MEC 035 draft indicates their usefulness for the needs of MEC system discovery, MEC platform discovery and the enablement of information exchange across a MEC federation, however, not referring to details on the information to be exchanged, the communication sequences involved and implementation ensuring security and trust of communication within a MEC federation. As such, what is needed is a comprehensive way to implement secure and trustworthy communication within a MEC federation of disparate regions and zones.

FIG. 6A illustrates a portion of a ETSI MEC reference architecture 600 enhanced with the federation communication and management techniques discussed herein. Here, the ETSI MEC reference architecture 600 includes an enhancement to the MEC System Level management layer with the addition of a Multi-access Edge Federation Broker (MEFB) 640 and a Multi-access Edge Federation Manager (MEFM) 630, connected with interfaces. The connection interfaces include the use of a Mfb-fed interface between the Manager 630 and the Broker 640, interface Mff-fed between federation manager instances (discussed in more detail below), and a Mfm-fed interface to the Multi-access Edge Orchestrator 620. (The orchestrator 620 is in turn connected to the Operations Support System 610 and other entities using the interfaces depicted in FIG. 5). It will be understood that the functional entity or interface additions indicated in FIGS. 6A and 6C may be implemented by way of standards or specifications.

As noted above, ETSI GR MEC 035 provides an analysis of solutions for enabling inter-MEC system communication. ETSI GR MEC 035 also introduces the concept of a MEC federation, defined as “a federated model of MEC systems enabling shared usage of MEC services and applications” (see also Clause 3.1 ETSI GR MEC 035). In this environment, different stakeholders collaborate for joint business purposes, and may “federate” their edge computing resources, by offering/exposing their MEC service capabilities, not only for mutual consumption, but also offering those to application developers and end customers (e.g. vertical market segments).

FIG. 6B illustrates a variant of the multi-access edge system reference architecture for the deployment in a MEC federation, usable with the presently described approaches. Here, in addition to the MEC System and MEC Host levels, a MEC Federation Management Level is added to host the MEC Federation Broker (MEFB) 640 and the MEC Federation Manager (MEFM) 630.

In an example, the presence of at least one MEFM is required in a MEC system in order to establish a federation to another system (i.e., another MEC system 660 or a Cloud System/Edge Cloud 650). At a high-level, the MEFM 630 is responsible for publishing details of the capabilities that the MEC system provides, while providing the MEC system with an access point to the capabilities and resources of other systems.

In some examples, the presence of the MEFB 640 is optional. When present, it is located between MEFMs (e.g., MEFM 630 and other MEFM 662). The MEFB 650 serves to act as a single point of access for each MEFM, thereby reducing the complexity of MEC federation establishment involving many MEC systems. Further, the MEFM entities of different MEC systems (e.g., other MEC system 660) are connected via the Mff-fed reference point if there is no MEFB, but if there is a MEFB then each MEFM can connect to that instead via the Mfb-fed reference point. In case of connection between a MEC system with an external cloud system, the same Mff-fed reference point definitions may be reused. Likewise, the Mfm-fed reference point interconnects a MEC system's MEO to its MEFM.

FIG. 6C illustrates another variant of the multi-access edge system reference architecture for the deployment in a MEC Federation. In this setting, the two entities MEFM 630 and MEFB 640 are provided as internal functionalities of a single functional entity, the MEC Federator 635 (MEF). In an example, the MEF 635 provides the key functionality required to interface with other MEFs and in that capacity can act as a broker between MEFs. The MEF 635 also interfaces to at least one orchestrator (e.g., MEO 620). The messages and data discussed herein which are provided between the MEFM 630 and the MEFB 640 may be handled within the federator MEF 635. Thus, the functionality of the interfaces Mff-fed and Mfb-fed may be merged into a single reference point, Mff. The Mff reference point between MEFC federators within the MEC Federation may be used for sharing information (e.g., MEC system information).

As also shown in FIG. 6C, the MEF 635 is enabled to communicate directly with another MEC Federator 664 of the other MEC system 664. Thus, the external messages discussed below may also apply to those communications directly between federators (e.g., establishing how different MEC systems in the federation have a dialogue with each other).

Thus, in an example, each MEF in the MEC architecture enables information exchange with at least one other MEF through support of the Mff reference point. Furthermore, a MEF may serve as a single point of contact (e.g., via the Mff reference point) for multiple MEFs in the MEC Federation, acting as a broker between different MEFs. In this scenario, a MEF is considered to be “broker capable” and contains MEFB functionality. MEFs also may be considered as “manager capable,” when containing MEFM functionality and supporting the Mfm reference point. The Mfm reference point between the MEC orchestrator 620 and the MEF 630 enables sharing information of a MEC system A MEF with MEFM and MEFB functionality is both “manager capable” and “broker capable.” In some examples, there may be more than one MEF that is “broker capable” in an overall MEC Federation.

In summary, within a MEC Federation, the MEF may support the following functionality: (i) registration of MEC system information by a MEO; (ii) MEC system discovery; (iii) broker capability acting as a one to many intermediary between MEFs; (iv) information (e.g., MEC system information) exchange; (v) application lifecycle management (e.g., on-boarding, instantiation, termination) across different MEC systems; and (vi) application monitoring across different MEC systems.

Although many of the following examples are provided with reference to separate broker and manager entities, it will be understood that such examples are equally relevant to the hosting of such entities within the MEC Federator 635. Accordingly, the proposed signaling and data structures discussed below for MEC federation still apply with use of this architecture variant (e.g., using a separate MEC Federator entity per MEC system and using the Mff reference point for inter-connecting MEC Federator entities of other MEC systems of the MEC Federation).

Even though techniques disclosed herein for federated MEC network functions are discussed in connection with MEC-related architectures where at least one MEC entity is present, the disclosure is not limited in this regard and the disclosed techniques may be used in architectures that do not use MEC entities. For example, techniques associated with federated networks can be performed in non-MEC architectures as well.

Even though techniques disclosed herein are described in connection with a MEC architecture and 5G architecture, the disclosure is not limited in this regard and the disclosed techniques can be used with other types of wireless architectures (e.g., 2G, 3G, 4G, etc.) that use one or more MEC entities, as well as according to any spectral management schemes. Additionally, the radio links described herein may operate according to any radio communication technologies and/or standards.

### Example Computing Devices

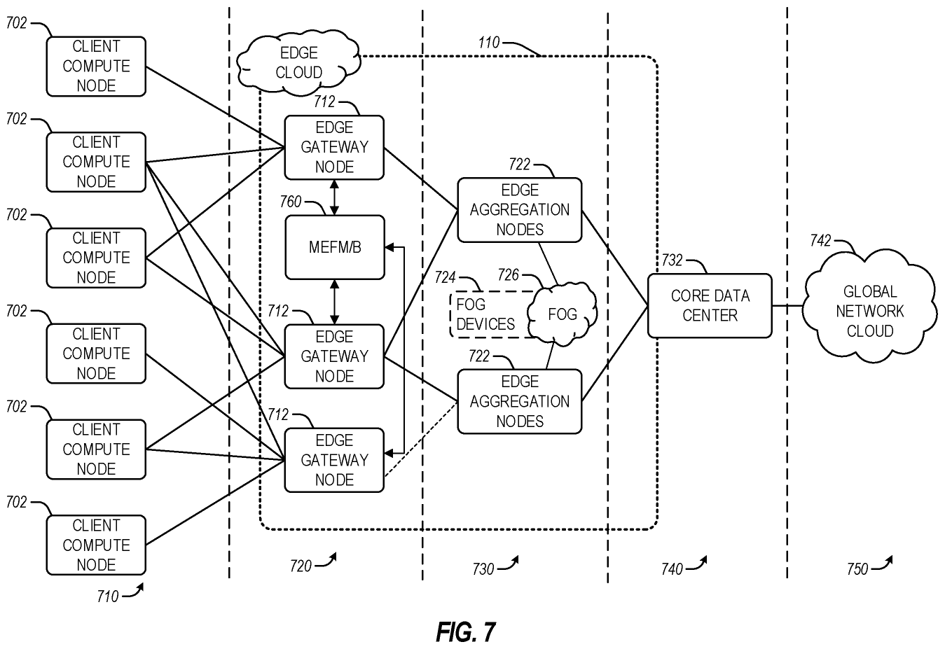

At a more generic level, an edge computing system may be described to encompass any number of deployments operating in the edge cloud 110, which provide coordination from client and distributed computing devices. FIG. 7 provides a further abstracted overview of layers of distributed compute deployed among an edge computing environment for purposes of illustration.

FIG. 7 generically depicts an edge computing system for providing edge services and applications to multi-stakeholder entities, as distributed among one or more client compute nodes 702, one or more edge gateway nodes 712, one or more edge aggregation nodes 722, one or more core data centers 732, and a global network cloud 742, as distributed across layers of the network. The implementation of the edge computing system may be provided at or on behalf of a telecommunication service provider (“telco”, or “TSP”), internet-of-things service provider, a cloud service provider (CSP), enterprise entity, or any other number of entities. Various forms of wired or wireless connections may be configured to establish connectivity among the nodes 702, 712, 722, 732, including interconnections among such nodes (e.g., connections among edge gateway nodes 712, and connections among edge aggregation nodes 722).

Each node or device of the edge computing system is located at a particular layer corresponding to layers 710, 720, 730, 740, and 750. For example, the client compute nodes 702 are each located at an endpoint layer 710, while each of the edge gateway nodes 712 is located at an edge devices layer 720 (local level) of the edge computing system. Additionally, each of the edge aggregation nodes 722 (and/or fog devices 724, if arranged or operated with or among a fog networking configuration 726) is located at a network access layer 730 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 732 is located at a core network layer 740 (e.g., a regional or geographically-central level), while the global network cloud 742 is located at a cloud data center layer 750 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 732 may be located within, at, or near the edge cloud 110.

Although an illustrative number of client compute nodes 702, edge gateway nodes 712, edge aggregation nodes 722, core data centers 732, and global network clouds 742 are shown in FIG. 7, it should be appreciated that the edge computing system may include more or fewer devices or systems at each layer. Additionally, as shown in FIG. 7, the number of components of each layer 710, 720, 730, 740, and 750 generally increases at each lower level (i.e., when moving closer to endpoints). As such, one edge gateway node 712 may service multiple client compute nodes 702, and one edge aggregation node 722 may service multiple edge gateway nodes 712.

Consistent with the examples provided herein, each client compute node 702 may be embodied as any type of end point component, device, appliance, or “thing” capable of communicating as a producer or consumer of data. Further, the label “node” or “device” as used in the edge computing system 700 does not necessarily mean that such node or device operates in a client or minion/follower/agent role; rather, any of the nodes or devices in the edge computing system 700 refer to individual entities, nodes, or subsystems which include discrete or connected hardware or software configurations to facilitate or use the edge cloud 110.

As such, the edge cloud 110 is formed from network components and functional features operated by and within the edge gateway nodes 712 and the edge aggregation nodes 722 of layers 720, 730, respectively. The edge cloud 110 may be embodied as any type of network that provides edge computing and/or storage resources which are proximately located to radio access network (RAN) capable endpoint devices (e.g., mobile computing devices, IoT devices, smart devices, etc.), which are shown in FIG. 7 as the client compute nodes 702. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 726 (e.g., a network of fog devices 724, not shown in detail), which may be embodied as a system-level horizontal and distributed architecture that distributes resources and services to perform a specific function. For instance, a coordinated and distributed network of fog devices 724 may perform computing, storage, control, or networking aspects in the context of an IoT system arrangement. Other networked, aggregated, and distributed functions may exist in the edge cloud 110 between the cloud data center layer 750 and the client endpoints (e.g., client compute nodes 702). Some of these are discussed in the following sections in the context of network functions or service virtualization, including the use of virtual edges and virtual services which are orchestrated for multiple stakeholders.

The edge gateway nodes 712 and the edge aggregation nodes 722 cooperate to provide various edge services and security to the client compute nodes 702. Furthermore, because each client compute node 702 may be stationary or mobile, each edge gateway node 712 may cooperate with other edge gateway devices to propagate presently provided edge services and security as the corresponding client compute node 702 moves about a region. To do so, each of the edge gateway nodes 712 and/or edge aggregation nodes 722 may support multiple tenancies and multiple stakeholder configurations, in which services from (or hosted for) multiple service providers and multiple consumers may be supported and coordinated across a single or multiple compute devices.

In various examples, the edge cloud 110 may include an MEFM/B 760 (which can be similar to the federation manager or broker entities, discussed in connection with FIGS. 5-6C and FIGS. 11-20) used for configuring and managing a MEC federation constituting of MEC systems, possibly owned and operated by different parties (e.g., MNOs). Other federation management functions are also discussed in connection with FIGS. 5-6C and FIGS. 11-20.

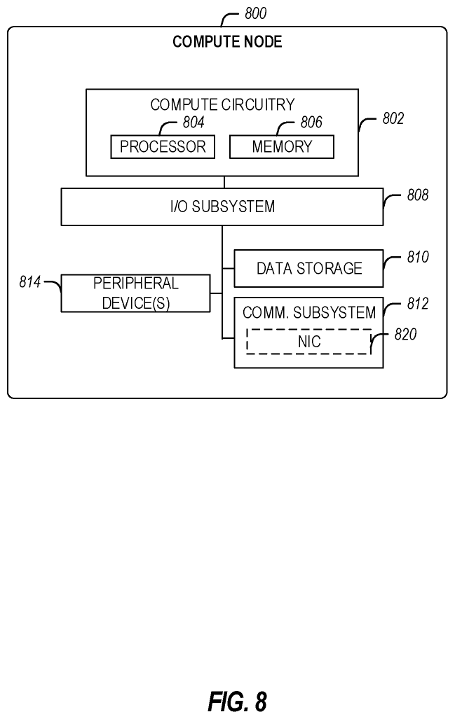

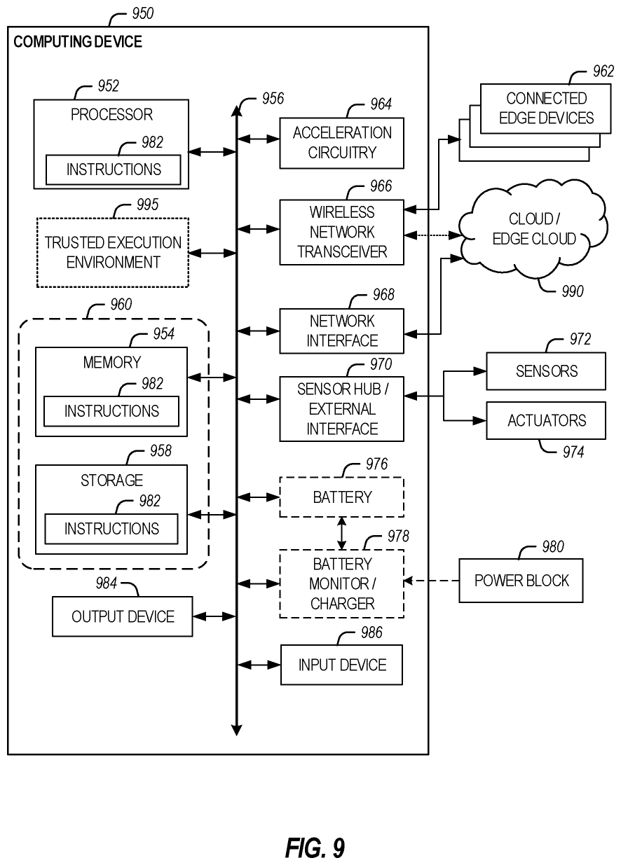

In further examples, any of the compute nodes or devices discussed with reference to the present edge computing systems and environment may be fulfilled based on the components depicted in FIGS. 8 and 9. Each edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 8, an edge compute node 800 includes a compute engine (also referred to herein as “compute circuitry”) 802, an input/output (I/O) subsystem 808, data storage 810, a communication circuitry subsystem 812, and, optionally, one or more peripheral devices 814. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 800 may be embodied as any type of engine, device, or collection of devices capable of performing various compute functions. In some examples, the compute node 800 may be embodied as a single device such as an integrated circuit, an embedded system, a field-programmable gate array (FPGA), a system-on-a-chip (SOC), or other integrated system or device. In the illustrative example, the compute node 800 includes or is embodied as a processor 804 and a memory 806. The processor 804 may be embodied as any type of processor capable of performing the functions described herein (e.g., executing an application). For example, the processor 804 may be embodied as a multi-core processor(s), a microcontroller, a processing unit, a specialized or special purpose processing unit, or other processor or processing/controlling circuit. In some examples, the processor 804 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 804 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized accelerators such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, a SOC, a CPU, and other variations of the processor 704 may work in coordination with each other to execute many types of operations and instructions within and on behalf of the compute node 800.

The main memory 806 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 806 may be integrated into the processor 804. The main memory 806 may store various software and data used during operation such as one or more applications, data operated on by the application(s), libraries, and drivers.

The compute circuitry 802 is communicatively coupled to other components of the compute node 800 via the I/O subsystem 808, which may be embodied as circuitry and/or components to facilitate input/output operations with the compute circuitry 802 (e.g., with the processor 804 and/or the main memory 806) and other components of the compute circuitry 802. For example, the I/O subsystem 808 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 808 may form a portion of a system-on-a-chip (SoC) and be incorporated, along with one or more of the processor 804, the main memory 806, and other components of the compute circuitry 802, into the compute circuitry 802.

The one or more illustrative data storage devices 810 may be embodied as any type of device configured for short-term or long-term storage of data such as, for example, memory devices and circuits, memory cards, hard disk drives, solid-state drives, or other data storage devices. Each data storage device 810 may include a system partition that stores data and firmware code for the data storage device 810. Each data storage device 810 may also include one or more operating system partitions that store data files and executables for operating systems depending on, for example, the type of compute node 800.

The communication circuitry 812 may be embodied as any communication circuit, device, or collection thereof, capable of enabling communications over a network between the compute circuitry 802 and another compute device (e.g., an edge gateway node 712 of the edge computing system 700). The communication circuitry 812 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 812 includes a network interface controller (NIC) 820, which may also be referred to as a host fabric interface (HFI). The NIC 820 may be embodied as one or more add-in-boards, daughter cards, network interface cards, controller chips, chipsets, or other devices that may be used by the compute node 800 to connect with another compute device (e.g., an edge gateway node 712). In some examples, the NIC 820 may be embodied as part of a system-on-a-chip (SoC) that includes one or more processors or included on a multichip package that also contains one or more processors. In some examples, the NIC 820 may include a local processor (not shown) and/or a local memory and storage (not shown) that are local to the NIC 820. In such examples, the local processor of the NIC 820 (which can include general-purpose accelerators or specific accelerators) may be capable of performing one or more of the functions of the compute circuitry 802 described herein. Additionally, or alternatively, the local memory of the NIC 820 may be integrated into one or more components of the client compute node at the board level, socket level, chip level, and/or other levels.

Additionally, in some examples, each compute node 800 may include one or more peripheral devices 814. Such peripheral devices 814 may include any type of peripheral device found in a compute device or server such as audio input devices, a display, other input/output devices, interface devices, and/or other peripheral devices, depending on the particular type of the compute node 800. In further examples, the compute node 800 may be embodied by a respective edge compute node in an edge computing system (e.g., client compute node 702, edge gateway node 712, edge aggregation node 722) or like forms of appliances, computers, subsystems, circuitry, or other components.

In a more detailed example, FIG. 9 illustrates a block diagram of an example of components that may be present in an edge computing device (or node) 950 for implementing the techniques (e.g., operations, processes, methods, and methodologies) described herein. The edge computing node 950 provides a closer view of the respective components of node 800 when implemented as or as part of a computing device (e.g., as a mobile device, a base station, server, gateway, etc.). The edge computing node 950 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 950, or as components otherwise incorporated within a chassis of a larger system.

The edge computing node 950 may include processing circuitry in the form of a processor 952, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 952 may be a part of a system on a chip (SoC) in which the processor 952 and other components are formed into a single integrated circuit, or a single package, such as the Edison™ or Galileo™ SoC boards from Intel Corporation, Santa Clara, California. As an example, the processor 952 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 952 and accompanying circuitry may be provided in a single socket form factor, multiple socket form factor, or a variety of other formats, including in limited hardware configurations or configurations that include fewer than all elements shown in FIG. 9.

The processor 952 may communicate with a system memory 954 over an interconnect 956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 958 may also couple to the processor 952 via the interconnect 956. In an example, the storage 958 may be implemented via a solid-state disk drive (SSDD). Other devices that may be used for the storage 958 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 958 may be on-die memory or registers associated with the processor 952. However, in some examples, the storage 958 may be implemented using a micro hard disk drive (HDD) or solid-state drive (SSD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in an SoC based system. Other bus systems may be included, such as an I2C interface, an SPI interface, point to point interfaces, and a power bus, among others.

The interconnect 956 may couple the processor 952 to a transceiver 966, for communications with the connected edge devices 962. The transceiver 966 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 962. For example, a wireless local area network (WLAN) unit may be used to implement Wi-FiR communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 966 (or multiple transceivers) may communicate using multiple standards or radios for communications at a different range. For example, the edge computing node 950 may communicate with close devices, e.g., within about 10 meters, using a local transceiver based on BLE, or another low power radio, to save power. More distant connected edge devices 962, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 966 (e.g., a radio transceiver) may be included to communicate with devices or services in the edge cloud 990 via local or wide area network protocols. The wireless network transceiver 966 may be an LPWA transceiver that follows the IEEE 802.15.4, or IEEE 802.15.4g standards, among others. The edge computing node 950 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 966, as described herein. For example, the transceiver 966 may include a cellular transceiver that uses spread spectrum (SPA/SAS) communications for implementing high-speed communications. Further, any number of other protocols may be used, such as Wi-Fi® networks for medium speed communications and provision of network communications. The transceiver 966 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 968 may be included to provide a wired communication to nodes of the edge cloud 990 or other devices, such as the connected edge devices 962 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 968 may be included to enable connecting to a second network, for example, a first NIC 968 providing communications to the cloud over Ethernet, and a second NIC 968 providing communications to other devices over another type of network.

Given the variety of types of applicable communications from the device to another component or network, applicable communications circuitry used by the device may include or be embodied by any one or more of components 964, 966, 968, or 970. Accordingly, in various examples, applicable means for communicating (e.g., receiving, transmitting, etc.) may be embodied by such communications circuitry.

The edge computing node 950 may include or be coupled to acceleration circuitry 964, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 956 may couple the processor 952 to a sensor hub or external interface 970 that is used to connect additional devices or subsystems. The devices may include sensors 972, such as accelerometers, level sensors, flow sensors, optical light sensors, camera sensors, temperature sensors, a global navigation system (e.g., GPS) sensors, pressure sensors, barometric pressure sensors, and the like. The hub or interface 970 further may be used to connect the edge computing node 950 to actuators 974, such as power switches, valve actuators, an audible sound generator, a visual warning device, and the like.

In some optional examples, various input/output (I/O) devices may be present within or connected to, the edge computing node 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 950. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 976 may power the edge computing node 950, although, in examples in which the edge computing node 950 is mounted in a fixed location, it may have a power supply coupled to an electrical grid, or the battery may be used as a backup or for temporary capabilities. The battery 976 may be a lithium-ion battery, or a metal-air battery, such as a zinc-air battery, an aluminum-air battery, a lithium-air battery, and the like.

A battery monitor/charger 978 may be included in the edge computing node 950 to track the state of charge (SoCh) of the battery 976. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 978 may communicate the information on the battery 976 to the processor 952 over the interconnect 956. The battery monitor/charger 978 may also include an analog-to-digital (ADC) converter that enables the processor 952 to directly monitor the voltage of the battery 976 or the current flow from the battery 976. The battery parameters may be used to determine actions that the edge computing node 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the edge computing node 950. A wireless battery charging circuit, such as an LTC4020 chip from Linear Technologies of Milpitas, California, among others, may be included in the battery monitor/charger 978. The specific charging circuits may be selected based on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application-specific integrated circuit (ASIC).

Also in a specific example, the instructions 982 on the processor 952 (separately, or in combination with the instructions 982 of the machine readable medium 960) may configure execution or operation of a trusted execution environment (TEE) 995. In an example, the TEE 995 operates as a protected area accessible to the processor 952 for secure execution of instructions and secure access to data. Various implementations of the TEE 995, and an accompanying secure area in the processor 952 or the memory 954 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 950 through the TEE 995 and the processor 952.

In an example, the instructions 982 provided via memory 954, the storage 958, or the processor 952 may be embodied as a non-transitory, machine-readable medium 960 including code to direct the processor 952 to perform electronic operations in the edge computing node 950. The processor 952 may access the non-transitory, machine-readable medium 960 over the interconnect 956. For instance, the non-transitory, machine-readable medium 960 may be embodied by devices described for the storage 958 or may include specific storage units such as optical disks, flash drives, or any number of other hardware devices. The non-transitory, machine-readable medium 960 may include instructions to direct the processor 952 to perform a specific sequence or flow of actions, for example, as described with respect to the flowchart(s) and block diagram(s) of operations and functionality depicted above. As used herein, the terms “machine-readable medium”, “computer-readable medium”, “machine-readable storage”, and “computer-readable storage” are interchangeable.

In an example embodiment, the edge computing node 950 can be implemented using components/modules/blocks 952-986 which are configured as IP Blocks. Each IP Block may contain a hardware ROT (e.g., device identifier composition engine, or DICE), where a DICE key may be used to identify and attest the IP Block firmware to a peer IP Block or remotely to one or more of components/modules/blocks 962-980. Thus, it will be understood that the node 950 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 8 and 9 is intended to depict a high-level view of components of a device, subsystem, or arrangement of an edge computing node. However, it will be understood that some of the components shown may be omitted, additional components may be present, and a different arrangement of the components shown may occur in other implementations.

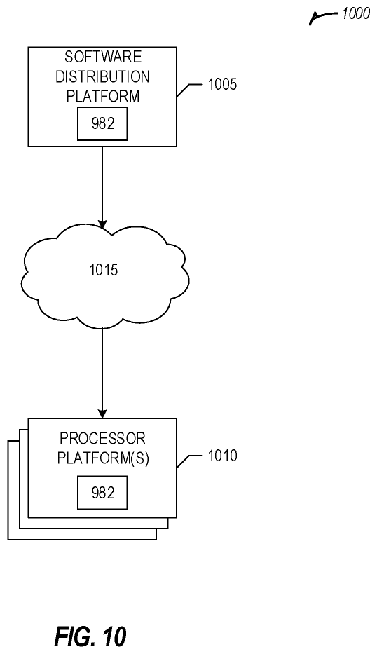

FIG. 10 illustrates an example software distribution platform 1005 to distribute software, such as the example computer readable instructions 982 of FIG. 9, to one or more devices, such as example processor platform(s) 1010 and/or other example connected edge devices or systems discussed herein. The example software distribution platform 1005 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1005). Example connected edge devices may operate in commercial and/or home automation environments. In some examples, a third party is a developer, a seller, and/or a licensor of software such as the example computer readable instructions 982 of FIG. 9. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 10, the software distribution platform 1005 includes one or more servers and one or more storage devices that store the computer readable instructions 982. The one or more servers of the example software distribution platform 1005 are in communication with a network 1015, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 982 from the software distribution platform 1005. For example, the software, which may correspond to example computer readable instructions, may be downloaded to the example processor platform(s), which is/are to execute the computer readable instructions 982. In some examples, one or more servers of the software distribution platform 1005 are communicatively connected to one or more security domains and/or security devices through which requests and transmissions of the example computer readable instructions 982 must pass. In some examples, one or more servers of the software distribution platform 1005 periodically offer, transmit, and/or force updates to the software (e.g., the example computer readable instructions 982 of FIG. 9) to ensure improvements, patches, updates, etc. are distributed and applied to the software at the end user devices.

In the illustrated example of FIG. 10, the computer readable instructions 982 are stored on storage devices of the software distribution platform 1005 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 982 stored in the software distribution platform 1005 are in a first format when transmitted to the example processor platform(s) 1010. In some examples, the first format is an executable binary in which particular types of the processor platform(s) 1010 can execute. However, in some examples, the first format is uncompiled code that requires one or more preparation tasks to transform the first format to a second format to enable execution on the example processor platform(s) 1010. For instance, the receiving processor platform(s) 1000 may need to compile the computer readable instructions 982 in the first format to generate executable code in a second format that is capable of being executed on the processor platform(s) 1010. In still other examples, the first format is interpreted code that, upon reaching the processor platform(s) 1010, is interpreted by an interpreter to facilitate execution of instructions.

### Example Federated MEC Framework Functionalities

In the context of a deployed system (such as the IoT system depicted in FIG. 4, the MEC system depicted in FIGS. 5-6C, the edge computing system depicted in FIGS. 7-10, or like variations of distributed computing architectures) the present techniques and configurations provide the capability for enabling secure cross-platform communication with use of a secure MEC federation broker/manager.

As context for the following discussion, a GSMA OP white paper (“Operator Platform Telco Edge Proposal”, October 2020) discusses an Operator Platform (OP) telecommunications provider architecture that defines the East/West Bound Interface (EWBI) connecting different partner Operator Platforms (equivalently MEC systems). This aspect is particularly relevant to inter-MEC systems and MEC-Cloud systems coordination in ETSI MEC standards (e.g., MEC 035). Thus, the following provides reference to EWBI, as an interface connecting two Federation Manager entities, or multiple Federation Managers to a single Federation Broker. However, Federation Manager and Federation Broker functional entities are only defined at high level in GSMA OP, not fully standardized in ETSI MEC architecture (e.g., not standardized in MEC 003 GS).

In a typical MEC Federation scenario (e.g., as described in the GSMA OPG White Paper on Edge Service Description and Commercial Principles for the Telco Edge Cloud (TEC)), there are multiple OP partners (MNOs and Edge Service Providers), eventually connected through an Edge Interconnection Hub. In this scenario, there is a need to improve the level of trust of OP partners in the MEC Federation, in order to enable further collaboration with multiple partners, and enhance the overall portfolio of service and resource offering to the customer. In fact, an improvement of the bilateral trust among the OP partners will ensure collaboration in the MEC Federation. Moreover, in the context of enabling edge service exposure among OP partners, there is also the need to ensure a fair shared use of commonly accessible resources via predefined OP partners agreements including charging principles toward the customers.

The following describes a MEC Federation framework capable of covering these needs. The framework involves: (i) the specification of MEC Federation Manager and MEC Federation Broker entities, and (ii) the definition of the EWBI interface of a MEC Federation including the involved information flows, required information, and operations.

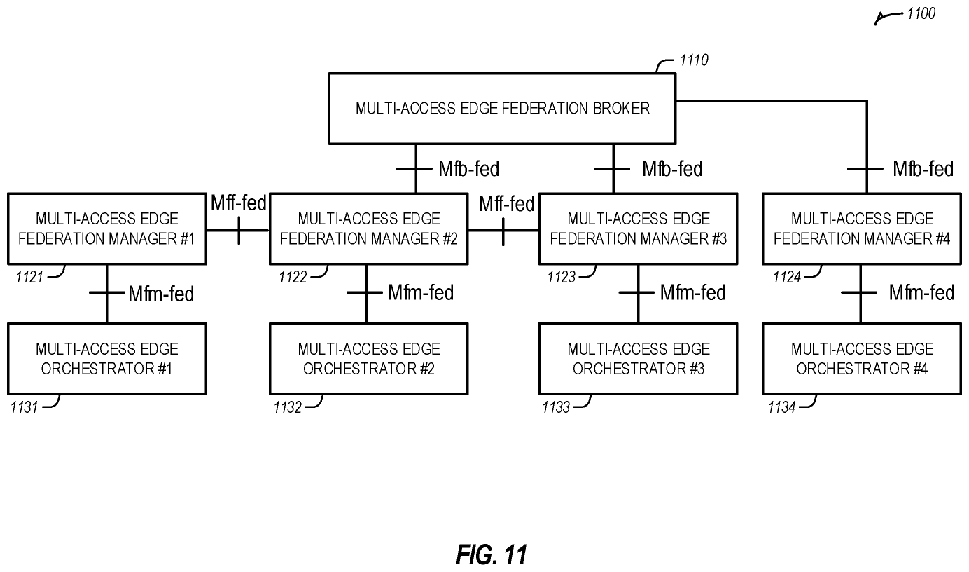

FIG. 11 depicts a high level overview of a proposed framework 1100, establishing connections between Federation Managers 1121-1124 and a Federation Broker 1110 in a MEC Federation. In this scenario, new elements “MEFM” (MEC Federation Manager) and “MEFB” (MEC Federation Broker) are added. In this configuration, all connections exemplify the entire set of possibilities when connecting Federation Managers and Brokers.

As discussed above, the current ETSI MEC reference architecture (MEC 003 GS, as well as the MEC 035 GR) lack detailed information on the needed functional entities and interfaces to form and operate a MEC Federation. Further, information elements and data models useful to a MEC Federation are provided in the GSMA OPG White Paper, however, the provided information is rather scattered and lacking a structured format for information exchange (as done in a typical API) as well as mechanisms to enhance security and trustworthiness across a MEC federation. Likewise, requirements from GSMA OPG, related to the set of data to be transferred via a EWBI interface, are provided in a generic list which lacks the technical details needed for the actual design and implementation of the EWBI interface. In particular, data fields, with attribute names, data type, cardinality are needed to be defined (and standardized) to allow interoperable information exchange and proper communication among the OP partners in the MEC federation.

From a security perspective, cybersecurity certification schemes do not fully address elements related to cloud/edge cloud equipment and implementation in a MEC Federation. For example, in Europe, ENISA (European Union Agency for Cybersecurity) is responsible for the implementation of the European Cybersecurity Act. The Act simply introduces three cybersecurity assurance levels (without giving further technical requirements): Basic; Substantial; High.

Finally, Security Domains defined in GSMA OP refer to 3GPP TS 33.210 on “Network Domain Security (NDS)”. In detail, when it comes to interconnection between different operators, this 3GPP specification states: “The actual inter-security domain policy is determined by roaming agreements when the security domains belong to different operators or may be unilaterally decided by the operator when the security domains both belong to him.” Nevertheless, an assessment of different levels of security among operators is not provided, as inter-security domain policy is typically determined by roaming agreements.

### Definition of MEC Federation Manager and MEC Federation Broker Entities

In an example, MEC Federation Manager (MEFM) and MEC Federation Broker (MEFB) entities are configured to operate in a Manager Role and a Broker Role, respectively, in accordance with GSMA OP requirements. These two new ETSI MEC entities are able to store and process additional/specific information related to the EWBI (according to GSMA OP).

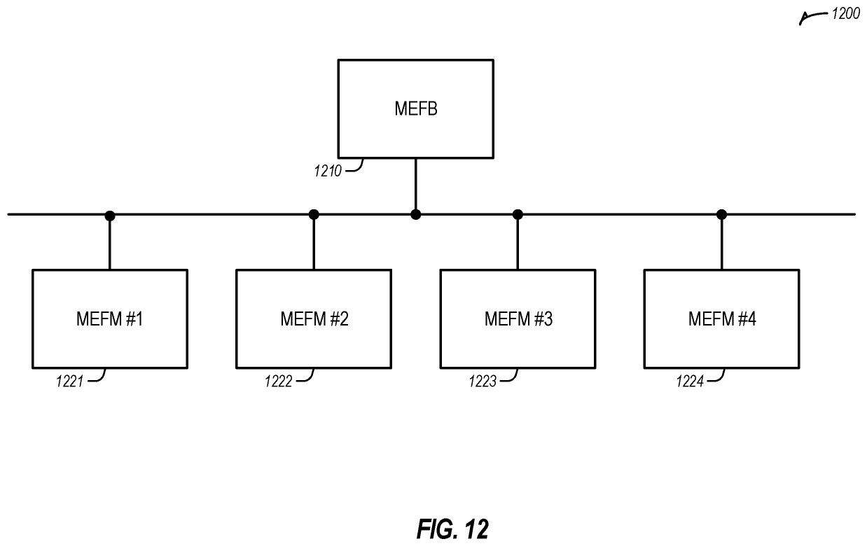

FIG. 12 shows an architecture 1200 having connections between federation managers (MEFM 1221-1224) and a broker (MEFB 1210). Each federation manager (MEFM 1221-1224) corresponds to a respective edge orchestrator (e.g., FIG. 11, MEO 1131-1134). Here, each MEFM 1221-1224 corresponds to a certain OP instance (identified by a certain OpID, e.g., the ID of the Operator Platform). In an example, this ID is unique per OP domain, consequently in a MEC Federation there can be multiple OP domains, which permit reuse of OpID codes.

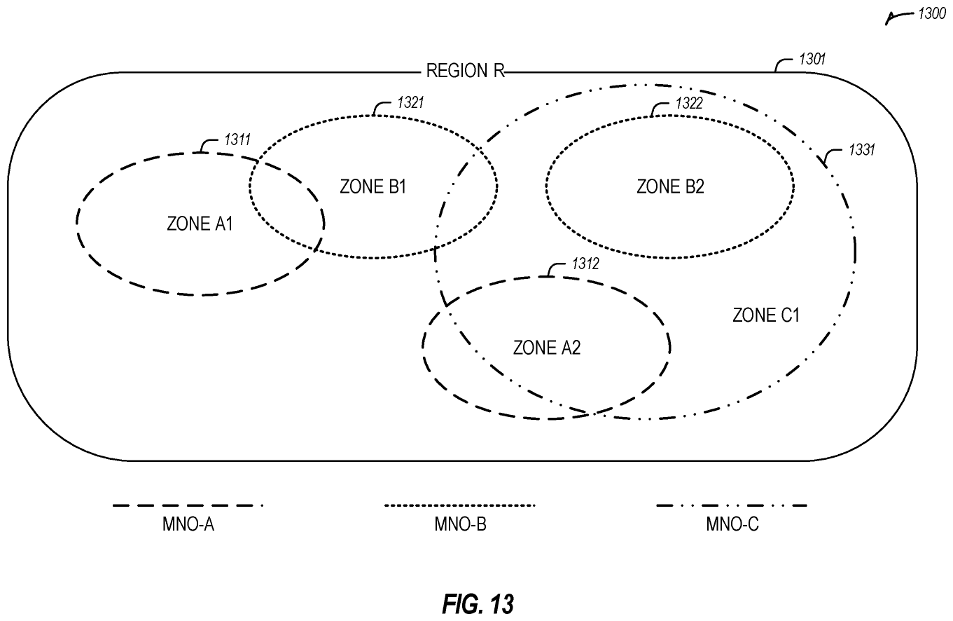

FIG. 13 depicts a block diagram 1300 of an implementation of zones and regions in a MEC Federation, according to an example. Here, a region R 1301 includes a set of zones 1311, 1312, 1321, 1322, 1331, which may partially or fully overlap. The zones may be owned, rented, managed, or otherwise associated with an MNO. In the example illustrated, MNO-A is associated with zones 1311 and 1312, MNO-B is associated with zones 1321 and 1322, and MNO-C is associated with zone 131. Note that a region (or, a zone) can correspond to a certain geographical area, e.g., also corresponding to a single country. It will be understood that a region may be defined based on geographic or geo-political boundaries; a region may also correspond to defined areas such as a state or province, a city, a business enterprise, or the like. In a similar fashion, a zone may be a subset of such areas or entities within a region; or, a zone may extend among multiple regions. Further, zones may be mutually exclusive or may overlap partially or fully on each other. Thus, a variety of constructs may be applied within a network for the definition of a zone or a region.

In an example, a MEC Federation is composed by multiple regions (e.g., countries), where typically within each region the different OP instances need to be connected. Consequently, within a certain region, the presence of a certain set of local (or “regional”) managers and a single “regional” broker may be used.

Accordingly, a hierarchical architecture may include separated domains of operation, where the various regional brokers need to communicate globally. It will be understood that in some examples, multiple brokers are not needed in a MEC federation. A single broker may be a possible option, but the use of a single broker would also correspond to a single-point-of-failure for the global MEC Federation. Further, because federated regions can be geographically decoupled from each other, it may be improper to orchestrate the entire “global” federation with a single broker. To address a need of local autonomy of regions, a single broker per region may be used as a deployment option.

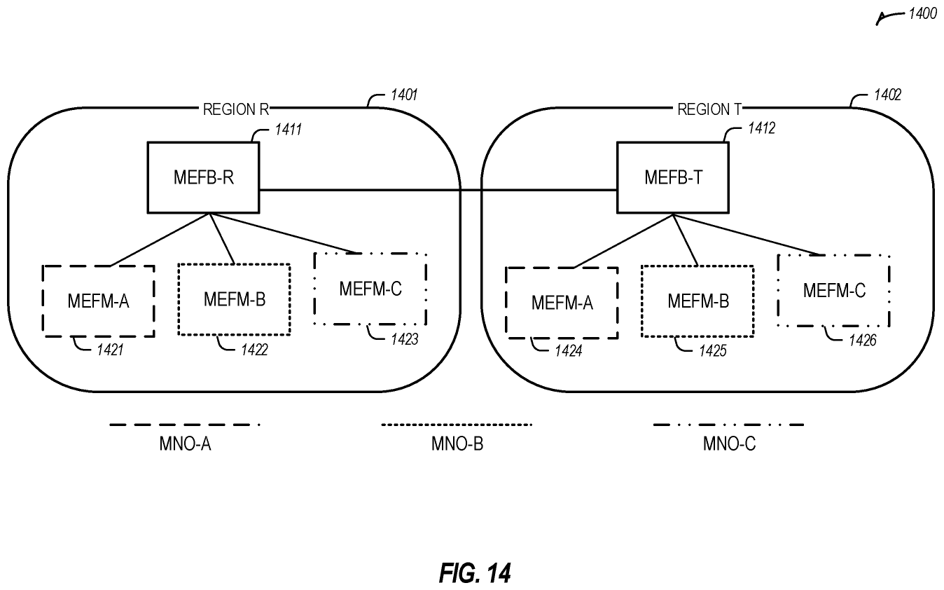

FIG. 14 depicts a block diagram 1400 of a hierarchical deployment of Brokers and Managers in multiple regions of a MEC Federation, according to an example. Here, a broker MEFB-R 1411 is defined in Region R 1401, and a broker MEFB-T 1412 is defined in Region T 1402. Each region then operates sets of federation managers (MEFM-A 1421, MEFM-B 1422, MEFM-C 1423 in Region R; and MEFM-A 1424, MEFM-B 1425, MEFM-C 1426 in Region T).

The hierarchical deployment of FIG. 14 introduces a new interface between multiple MEFBs (e.g., between MEFB-R 1411 and MEFB-T 1412). However, this new interface may replicate the same data formats and messages as a EWBI connection. One difference is that the coordination is made at higher level (between brokers in different regions). Nonetheless, such an interface is still not present in the GSMA OP. Hence, this hierarchical deployment may be considered a requirement for the next phase of GSMA OPG activities.

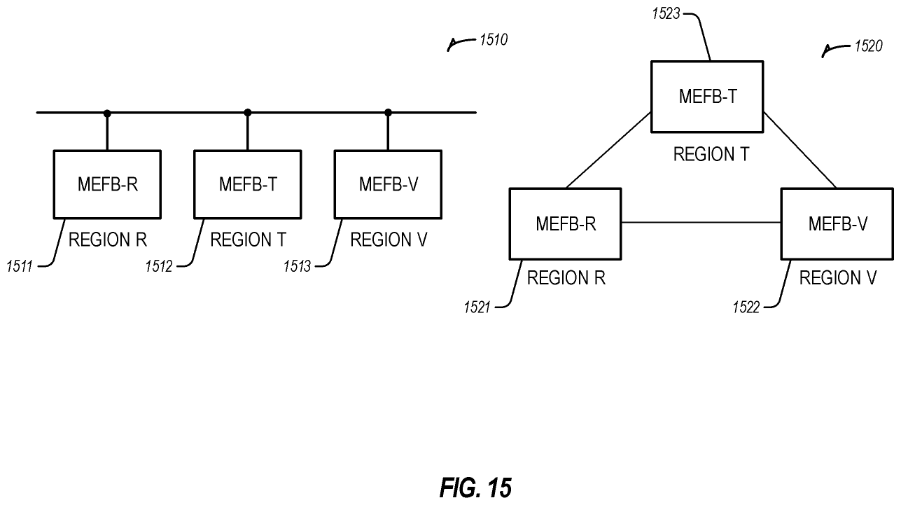

FIG. 15 depicts topology options, including topology 1510 and topology 1520, for connecting brokers 1511-1513 (or 1521-1523) across regions in a global MEC Federation. Having multiple brokers (each one in charge of a single region) may require synchronization in order to allow cross-country edge service consumption. For that reason, any kind of communication topology may connect brokers across a MEC Federation, e.g., by means of bus, star, ring, mesh, or hybrid arrangement (as illustrated in FIG. 15). The particular choice of topology may be driven by deployment and practical deployment reasons.

### Data and Information Specifications for the EWBI (East-Westbound Interface) of a MEC Federation

The set of data defined herein may be transferred via EWBI, thus connecting different ETSI MEC systems. More specifically, the following defines new reference points in ETSI MEC that are used to interconnect the new functional entities of the ETSI MEC architecture with one another and with the appropriate existent ones.

Data types relevant to a MEC Federation's EWBI may include the following. TABLE 1 shows the structures of a first set of data types—relevant to system attributes—aiming to be exchanged between either: i) MEFM entities (via the Mff-fed reference point); ii) between an MEFM and an MEFB (via the Mfb-fed reference point); or iii) between an MEO and its corresponding MEFM, including the attributes these data types are composed of, and their optionality or cardinality.

TABLE 1
Attributes of the PartnerSystemInfo data type (applicable
to reference points Mff-fed and Mfb-fed):

| | | Cardi- | |
|---|---|---|---|
| Attribute name | Data type | nality | Description |
| partnerName | String | 1 | Human-readable name of |
| | | | partner system. |
| partnerId | String | 1 | Unique identifier for |
| | | | partner MEC system. |
| partnerGeoArea | LocationInfo | 1 | Geographical area |
| | | | covered by partner |
| | | | system (e.g., cell ID |
| | | | or a geographical area). |
| partnerFedEndpoint | AssocEndpoint | 1 | Partner system's federa- |
| | | | tion reference point's |
| | | | (Mff-fed or Mfb-fed) |
| | | | endpoint. |
| fedAgreeDuration | TimeStamp | 1 | The federation agreement |
| | | | validity duration. |

To handle cybersecurity assessment and related information to be communicated among the various entities of the MEC Federation (and thus applicable to reference points Mff-fed and Mfb-fed), the following introduces a suitable data type partnerAuthent Info, enhanced with specific data fields that provide an indication of the cybersecurity assurance levels, according to the European Cybersecurity Act (CSA) published by ENISA. As already discussed, the act introduces three cybersecurity assurance levels (Basic, Substantial and High). Consequently, values for these data fields (e.g. secAssessmentOverall) may be provided by the corresponding data set:
0=N/A
1=BASIC
2=SUBSTANTIAL
3=HIGH

Where, if none of the three CSA assurance levels apply, the indication “N/A”, or equivalently “NONE”, or similar (which sometimes can be also meaningful of “NOT TRUSTED”) can be used.

TABLE 2
Attributes of the PartnerAuthentInfo data type (applicable
to reference points Mff-fed and Mfb-fed):

| | Data | Cardi- | |
|---|---|---|---|
| Attribute name | type | nality | Description |
| partnerAuthentInfo | Structure | 1 | Information needed for |
| | (inlined) | | the system to |
| | | | authenticate itself to a |
| | | | partner system. |
| >digCertificate | String | 0 . . . 1 | Digital certificate. |
| >passphrase | String | 0 . . . 1 | Passphrase |
| >secAssessmentOverall | Enum | 1 | Indicates the overall |
| | | | trustworthiness level |
| | | | of the partner system. |
| | | | Values are defined |
| | | | as following: |
| | | | 0 = N/A |
| | | | 1 = BASIC |
| | | | 2 = SUBSTANTIAL |
| | | | 3 = HIGH |
| >secAssessmentDetails | Structure | 1 . . . N | Security assessment of |
| | (inlined) | | MEC hosts/cloudlets |
| | | | constituting the |
| | | | partner system. |
| >>secAssessmentPlatform | Enum | 1 | Indicates the |
| | | | trustworthiness level |
| | | | of a MEC platform. |
| | | | Values are defined |
| | | | as following: |
| | | | 0 = N/A |
| | | | 1 = BASIC |
| | | | 2 = SUBSTANTIAL |
| | | | 3 = HIGH |
| >>secAssessmentApi | Enum | 1 . . . N | Indicates the |
| | | | trustworthiness level |
| | | | of an involved API. |
| | | | Values are defined |
| | | | as following: |
| | | | 0 = N/A |
| | | | 1 = BASIC |
| | | | 2 = SUBSTANTIAL |
| | | | 3 = HIGH |
| >>secAssessmentApp | Enum | 1 . . . N | Indicates the |
| | | | trustworthiness level |
| | | | of an instantiated |
| | | | MEC application. |
| | | | Values are defined |
| | | | as following: |
| | | | 0 = N/A |
| | | | 1 = BASIC |
| | | | 2 = SUBSTANTIAL |
| | | | 3 = HIGH |
| >>secAssessmentDataPlane | Enum | 1 | Indicates the |
| | | | trustworthiness level |
| | | | of a MEC host's/ |
| | | | Cloudlet's data plane. |
| | | | Values are defined as |
| | | | following: |
| | | | 0 = N/A |
| | | | 1 = BASIC |
| | | | 2 = SUBSTANTIAL |
| | | | 3 = HIGH |
| >>secAssessmentVirtInfra | Enum | 1 | Indicates the |
| | | | trustworthiness level |
| | | | of a MEC host's/ |
| | | | Cloudlet's virtualized |
| | | | infrastructure. Values |
| | | | are defined as |
| | | | following: |
| | | | 0 = N/A |
| | | | 1 = BASIC |
| | | | 2 = SUBSTANTIAL |
| | | | 3 = HIGH |
| >>secAssessmentProcUnit | Enum | 1 . . . N | Indicates the |
| | | | trustworthiness level |
| | | | of a MEC host's/ |
| | | | Cloudlet's processing |
| | | | unit(s). Values are |
| | | | defined as following: |
| | | | 0 = N/A |
| | | | 1 = BASIC |
| | | | 2 = SUBSTANTIAL |
| | | | 3 = HIGH |
| >>secAssessmentStor- | Enum | 1 . . . N | Indicates the |
| ageUnit | | | trustworthiness level |
| | | | of a MEC host's/ |
| | | | Cloudlet's storage |
| | | | unit(s). Values are |
| | | | defined as following: |
| | | | 0 = N/A |
| | | | 1 = BASIC |
| | | | 2 = SUBSTANTIAL |
| | | | 3 = HIGH |
| >>secAssessmentConnec- | Enum | 1 . . . N | Indicates the |
| tivity | | | trustworthiness level |
| | | | of a MEC host's/ |
| | | | Cloudlet's connectivity |
| | | | unit (e.g., network |
| | | | interface cards - |
| | | | NICs). |
| | | | Values are defined |
| | | | as following: |
| | | | 0 = N/A |
| | | | 1 = BASIC |
| | | | 2 = SUBSTANTIAL |
| | | | 3 = HIGH |

NOTE:
A partner system is considered as trusted only in case all system components have been assessed likewise, otherwise it is considered partly trusted.

TABLE 3
Attributes of the PartnerAuthorInfo data type (applicable
to reference points Mff-fed and Mfb-fed)

| Attribute name | Data type | Cardinality | Description |
|---|---|---|---|
| partnerAuthorInfo | Structure | 1 | Authorization information |
| | (inlined) | | provided by the system to a |
| | | | partner system. |
| >accessToken | String | 1 | Access token value. |
| >tokenValidityPeriod | TimeStamp | 1 | Access token validity time period. |
| >tokenScope | Enum | 1 | Indicates the partner system |
| | | | authorization limits. Values are |
| | | | defined as following: |
| | | | 1 = DURATION. |
| | | | 2 = AVAILABILITY_ZONE. |
| | | | 3 = |
| | | | DURATION_&_AVAILABILITY_ZONE |
| | | | 4 = ACCESS_METHOD |

TABLE 4
Attributes of the AvailabilityZone data type (applicable to
all three reference points, i.e., Mfm-fed, Mff-fed, Mfb-fed)

| Attribute name | Data type | Cardinality | Description |
|---|---|---|---|
| regionIdentifier | LocationInfo | 1 | Identifier of a region, such as the cell |
| | | | of a base station or a particular |
| | | | geographical area. |
| compResources | Structure | 1 | A catalogue of offered computing |
| | (inlined) | | resources (CPU, memory, storage). |
| >cpuResource | Uint8 | 1 | Offered CPU resources in the |
| | | | availability zone. |
| >memResource | Uint8 | 1 | Offered memory resources in the |
| | | | availability zone. |
| >storResource | Unit8 | 1 | Offered storage resources in the |
| | | | availability zone. |
| specResources | Structure | 0 . . . 1 | A catalogue of offered specialized |
| | (inlined) | | (add-on) computing resources. |
| >gpuResources | Unit8 | 0 . . . 1 | Offered Graphic Processing Unit |
| | | | (GPU) resources in the availability |
| | | | zone. |
| >vpuResources | Unit8 | 0 . . . 1 | Offered Vision Processing Unit (VPU) |
| | | | resources in the availability zone. |
| >npuResources | Unit8 | 0 . . . 1 | Offered Neural Processing Unit (NPU) |
| | | | resources in the availability zone. |
| >fpgaResources | Unit8 | 0 . . . 1 | Offered Field-Programmable Gate |
| | | | Array (FPGA) resources in the |
| | | | availability zone. |

TABLE 5
Attributes of the ManagementSettlementData data type (applicable
to all three reference points, i.e., Mfm-fed, Mff-fed, Mfb-fed)

| Attribute name | Data type | Cardinality | Description |
|---|---|---|---|
| resourceType | Enum | 1 | Indicates the type of |
| | | | resources used by the |
| | | | partner system. Values are |
| | | | defined as following: |
| | | | 1 = CPU. |
| | | | 2 = MEMORY. |
| | | | 3 = STORAGE |
| | | | 4 = SPECIAL_RESOURCES |
| resourceQuantityused | Uint8 | 1 | Amount of the partner |
| | | | system's resources used. |
| numAppInstancesUsed | Uint8 | 1 | Number of the partner |
| | | | system's application |
| | | | instances used. |
| numUserSessionsServed | Uint8 | 1 | Number of user sessions |
| | | | served by the partner |
| | | | system. |
| resourceUsageTime | TimeStamp | 1 | Usage time of the partner |
| | | | system's resources. |
| additionalServicesDeployed | String | 1 | Additional services |
| | | | employed by the partner |
| | | | system. |

Following the framework discussed in the GSMA OP White Paper, management and settlement data can be used as an input for billing, audit and settlement purposes. With regards to referenced structure data types i.e., LocationInfo, TimeStamp and AssocEndpoint, the first two can be also found in ETSI MEC API specifications, such as ETSI GS MEC 030, whereas, the AssocEndpoint data type may be defined similarly to the Associateld reference structured data type of ETSI GS MEC 012 (e.g., discussed in Clause 6.5.4 of GS MEC 030).

In a further example, a publish/subscribe (pub-sub) mechanism may be defined for EWBI. According to GSMA OPG, not all data is mandatory. In general, optionality of data can be an issue in terms of interoperability. Thus, as a technical solution, the following proposes a pub-sub mechanism to discover and expose the additional set of data fields, which can be eventually absent in some managers.

The AvailabilityZone data type is used as an example which includes both mandatory and optional attributes. The proposed subscription/notification mechanism can be part of a Federation Management Information Service (FMIS) accompanied by a corresponding Federation Management Information API (FMI API). This service is available for authorized MEFM/MEFB entities of a MEC federation and is discovered over the Mff-fed/Mfb-fed reference point, respectively.

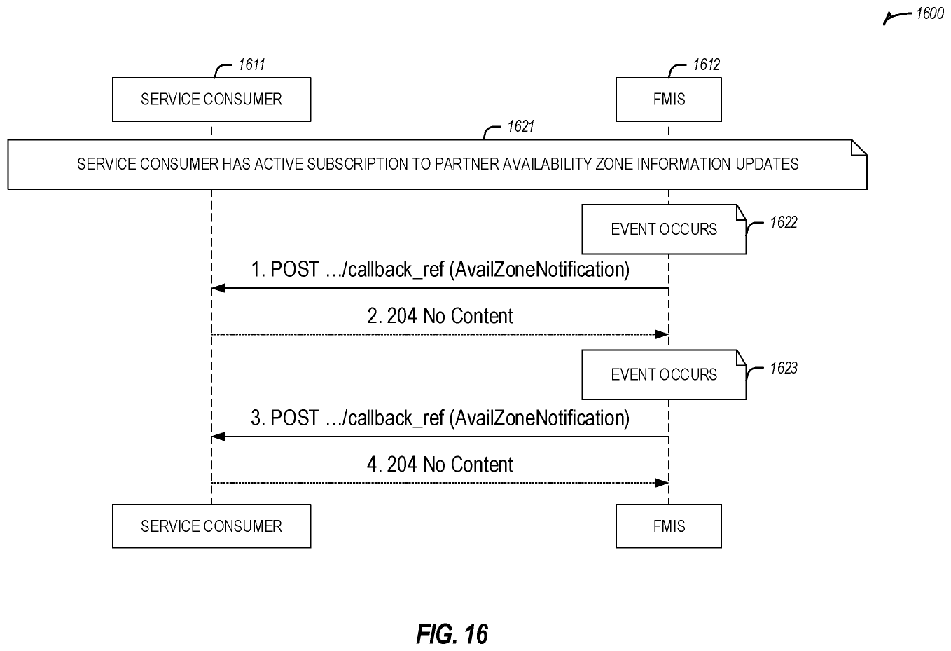

FIG. 16 depicts the flow 1600 of a MEFM/MEFB of a MEC federation receiving FMI event notifications on the existence of additional availability zone information. This may occur in a setting where a Service Consumer 1611 has an active subscription to information updates from a Partner Availability Zone, such as FMIS 1612 (condition 1621). The receiving of FMI event notifications on availability zone information updates, such as in response to occurrence of an event 1622, 1623 as illustrated in FIG. 16, includes the following operations:

1) FMIS 1612 sends a POST request with the message body containing the AvailZoneNotification data structure to the callback reference address included by the Service Consumer 1611 (i.e., a subscribed MEFM or MEFB) in the FMI availability zone information event subscription.

2) Service Consumer 1611 sends a “204 No Content” response to the FMIS.

In TABLE 6, the AvailZoneNotification data type is described.

TABLE 6
Attributes of the AvailZoneNotification data type (applicable
to reference points Mff-fed and Mfb-fed):

| Attribute name | Data type | Cardinality | Description |
|---|---|---|---|
| notificationType | String | 1 | Shall be set to |
| | | | “AvailZoneNotification”. |
| timeStamp | TimeStamp | 0 . . . 1 | Time stamp. |
| regionIdentifier | LocationInfo | 1 | Identifier of a region, such |
| | | | as the cell of a base station |
| | | | or a particular geographical |
| | | | area. |
| availabilityZoneUpdate | AvailabilityZone | 1 | Updated availability zone |
| | | | information with either (i) |
| | | | additional attributes, ii) |
| | | | changes in attribute |
| | | | optionality, or (iii) changes |
| | | | in values of existent |
| | | | attributes. |

### Information Exchange as a Top-Down Approach to Security and Attestation

The EWBI interface includes many types of exposed/consumed resources (not only edge cloud hardware and software, but also specific compute components, and also software instances such as toolkits, other MEC apps, etc.).

A top-down, prerequisite-based security assessment flow can follow a hierarchical order, where at each level (e.g. from top to down) a security assessment should be provided via attestation, in order to let the MEC Federation Broker entities able to communicate at highest OP level, and exchange the security information related to their respective OP instances.

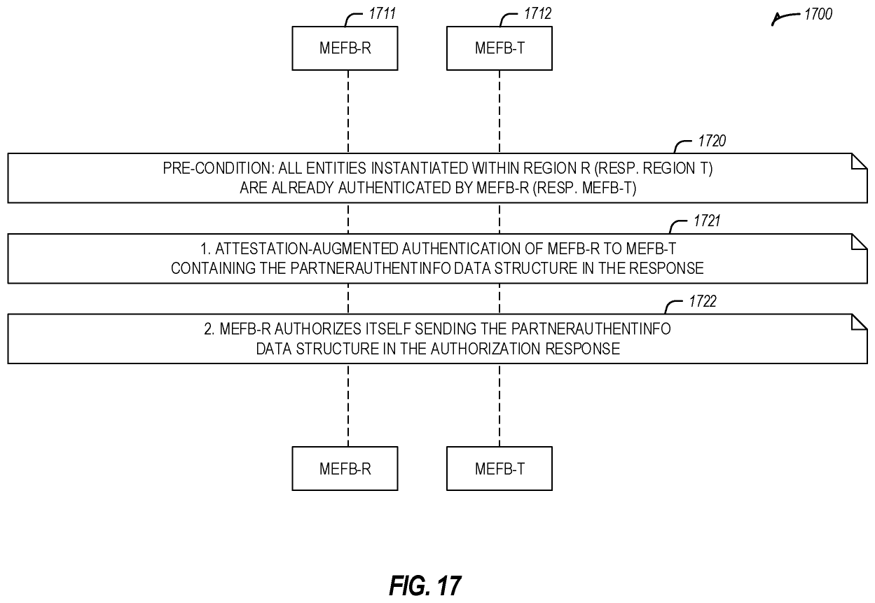

FIG. 17 depicts an attestation augmented authentication procedure 1700 in a MEC federation involving two MEFB entities: MEFB-R 1711 (e.g., in Region R) and MEFB-T 1712 (e.g., in Region T). Here, FIG. 17 provides an example of highest-OP-level communication, according to which a first MEFB entity (MEFB-R 1711) authenticates itself towards a second MEFB entity (MEFB-T 1712). This authentication occurs by means of an attestation-augmented authentication, where MEFB-R attests to MEFB-T and is subsequently authorized to communicate with MEFB-T and exchange information.

The entities (software, hardware, MEC apps, APIs) in region R to be shared across the MEC federation may be abstracted by information data types such as the ones introduced above. In turn, these data types authenticate themselves against MEFB-T and are authorized to be maintained at MEFB-T and to be capable of providing updates per the detailed pub-sub mechanism over the EWBI.

In more detail, the authentication procedure 1700 includes a precondition 1720, where all entities instantiated within a first region (e.g., Region R, responding to Region T) are already authenticated by a federation broker (e.g., MEFB-R 1711, responding to MEFB-T 1712). Next, an operation 1721 includes the attestation-augmented (AA) operation of the first federation broker (MEFB-R 1711) to the second federation broker (MEFB-T 1712). Then, at operation 1722, the first federation broker (MEFB-R 1711) authorizes itself for sending the PartnerAuthentInfo data structure, in the authorization response.

As an alternative (captured by the precondition 1720 discussed with reference to FIG. 17), all resource, application, etc. abstractions within region R can undergo authentication/authorization (AA) against MEFB-R. Then, to be reached by MEFB-T and entities within region T, an AA procedure can be performed between MEFB-R 1711 and MEFB-T 1712 over the EWBI.

In further examples, a specification landing zone may be defined, e.g., by additional specifications or enhancements provided by ENISA. Such specifications may provide security enhancements introduced by the MEC Federation Manager and MEC Federation Broker functional entities discussed herein.

In the framework above, a hierarchical approach is provided where at each level (e.g., from top to bottom) a security assessment is provided via attestation. This is applicable even as different OP instances are connected in a MEC Federation (depending on how each OP is composed, e.g., with different components from MNOs and Edge Service providers). In further examples, this technique can divide the assessment flow in two main levels: MEC Federation level (OP instances) and Edge Platform level (both from MNO and Edge Service provider).

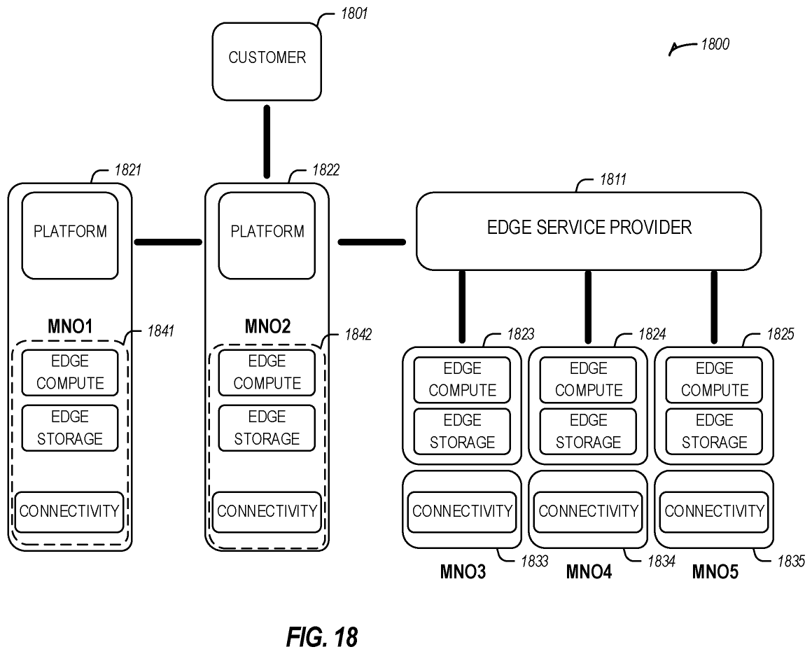

Assessment Flow at MEC Federation level (OP instances). FIG. 18 depicts a MEC Federation level architecture 1800 adapted for security assessment via attestation. At this level the first step to follow is the decomposition of each OP instance depending on the business relationships and the presence of different stakeholders (e.g., whether the MNO is offering its own access to the end customer 1801, or relying on an Edge Service Provider 1811, who is acting as aggregator). For instance, edge platform assistance may be performed by the platform of MNO1 1821, the platform of MNO2 1822, or the edge service provider 1811 (e.g., in scenarios where the each of the MNOs 1821, 1822 is implementing its own platform, and where this assistance implemented directly at the Edge Service Provider 1811).

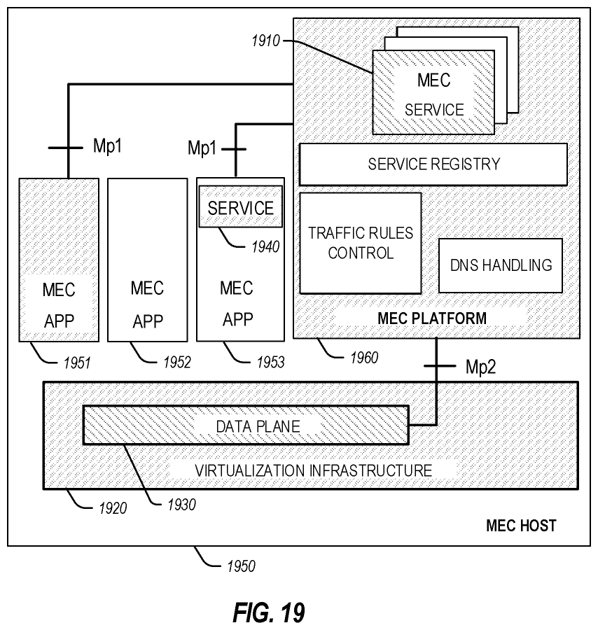

Assessment Flow at Edge Platform level (both from MNO and Edge Service provider). FIG. 19 depicts a MEC Platform level architecture adapted for security assessment via attestation. At this level, there are multiple ways to implement edge platforms. Using the ETSI MEC architecture as a reference, the security assessment can be defined at any of the indicated entities: from Apps (e.g., as illustrated, MEC app 1951) to APIs (e.g., as illustrated, services 1940, 1910) to MEC Platform (e.g., MEC platform 1960) to Data Plane (e.g., Data Plane 1930) and NFVI layer (e.g., Virtualization Infrastructure 1920). Then, going down to hardware and eventually also GPUs, FPGA and other computing resources, subcomponents are implemented (e.g., in FIG. 18, with hardware components 1841, 1842, 1823, 1824, 1824, 1825). Finally, the underlying network infrastructure/connectivity is identified (e.g., in FIG. 18, with connectivity components 1833, 1834, 1835), but also part of the attestation operations when owned by the same stakeholder, i.e. the MNO).

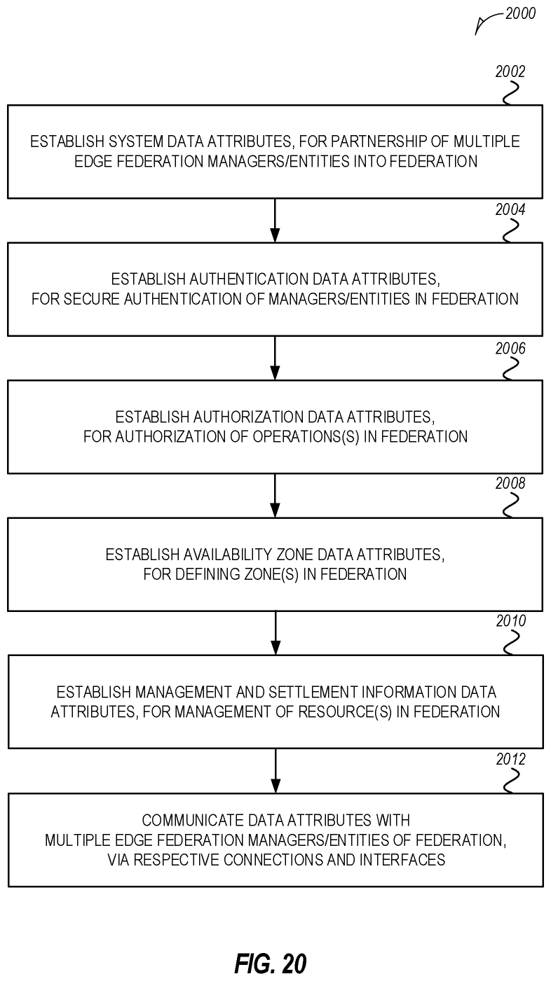

FIG. 20 illustrates a flowchart 2000 of a method for performing edge federation management functions. As will be understood, the following operations of the flowchart 2000 are depicted from the perspective of an edge federation broker in an edge computing system, such as may be performed by the MEFB discussed above. However, other entities (such as a federation manager or set of federation managers, orchestrator, etc.) may also be involved for use of the following federation management operations.

Operation 2002 includes establishing (e.g., defining, determining, identifying, specifying, etc.) system data attributes to establish a partnership among multiple edge federation managers. This partnership is used to provide a federation of multiple managers or system entities from multiple edge computing systems, as discussed herein. In an example, such system data attributes are provided by the data attributes specified in TABLE 1, above.

Operation 2004 includes establishing (e.g., defining, determining, identifying, specifying, etc.) authentication data attributes, to enable the multiple edge federation managers to securely authenticate in the federation. In an example, such authentication data attributes are provided by the data attributes specified in TABLE 2, above. In further examples, trustworthiness properties may be managed in the federation using such authentication data attributes. Such properties may include trustworthiness properties for at least one of: the edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

Operation 2006 includes establishing (e.g., defining, determining, identifying, specifying, etc.) authorization data attributes to enable the multiple edge federation managers to perform authorization operations in the federation, such as to authorize specific actions and activities among the multiple computing systems. In an example, such authorization data attributes are provided by the data attributes specified in TABLE 3, above.

Operation 2008 includes establishing (e.g., defining, determining, identifying, specifying, etc.) availability zone data attributes to define zones applicable in the federation among the multiple edge federation managers. In an example, such availability zone data attributes are provided by the data attributes specified in TABLE 4, above. Further, the region and zone arrangements may be arranged as discussed with reference to FIG. 13 and surrounding paragraphs above. The availability zone notification information defined in TABLE 6, above, may also be used. In further examples, resource availability properties may be managed in the federation using such availability zone data attributes. Such properties may relate to definitions for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.

Operation 2010 includes establishing (e.g., defining, determining, identifying, specifying, etc.) management and settlement information data attributes, to enable management of resources in the federation among the multiple edge federation managers. In an example, such management and settlement information data attributes are provided by the data attributes specified in TABLE 5, above. In further examples, operational properties may be managed in the federation using such management and settlement data attributes. Such properties may relate to definitions for at least one of: types of resources; amount of resources used; number of application instances; number of user sessions; usage time; or an identification of additional services.

Operation 2012 includes communicating the established attributes (e.g., the system data attributes, the authentication data attributes, the authorization data attributes, the availability zone data attributes, and the management and settlement data attributes) via respective connections with the multiple edge federation managers, to allow configuration and use of the federation.

The operations of flowchart 2000 may be applicable to a variety of configurations discussed above. These include a configuration of an edge computing system provides a first edge federation broker operating in a first region, to perform the operations of flowchart 2000, where the first edge federation broker coordinates the partnership among the multiple edge federation managers. In this setting, the respective connections with the multiple edge federation managers may be established via communication hardware (devices or circuitry). For instance, a first interface may be used to communicate between the first edge federation broker and a first edge federation manager of the edge computing system, and a second interface may be used to communicate between the first edge federation broker and a second edge federation manager of a second edge computing system. In a further example, the broker may cause performance of an attestation-augmented authentication procedure among the multiple edge federation managers, based on authentication performed using the first edge federation broker and a second edge federation broker of a second edge computing system.

In another further example, the entity performing the operations of flowchart 2000 may initiate computing operations in the federation with at least one of the multiple edge federation managers. In this setting, the respective connections may include an east-westbound interface (EWBI) of the federation that can perform information flows and coordinate the computing operations among the multiple edge federation managers.

In another further example, the entity performing the operations of flowchart 2000 may operate within defined regions as discussed above (e.g., described with reference to FIGS. 13 to 17). In an example, the federation is established to join at least the edge computing system located at a first region with at least a second edge computing system located at a second region. Also in an example, each region includes a plurality of zones for operation of the federation, and the plurality of zones correspond to respective mobile network operators operating in each region.

In another further example, the edge computing systems used for performing or implementing the operations of flowchart 2000 may be respective multi-access edge computing (MEC) systems, with each of the MEC systems having a plurality of MEC hosts, such that federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host (e.g., as discussed with reference to FIG. 19). Further, as provided in many of the examples above, the federation may operate according to a European Telecommunications Standards Institute (ETSI) Multi-Access Edge Computing (MEC) specification.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is an edge computing system, configured for enabling edge federation management in an edge computing network, comprising: communications circuitry configured to communicate with a plurality of federation managers, the plurality of federation managers located in (e.g., operating among) multiple computing nodes in the edge computing network; and processing circuitry configured to: identify and/or define system data attributes to establish a partnership among multiple edge federation managers as a federation of edge computing systems; identify and/or define authentication data attributes to enable the multiple edge federation managers to securely authenticate in the federation; identify and/or define authorization data attributes to enable the multiple edge federation managers to perform authorization operations in the federation; identify and/or define availability zone data attributes to define zones applicable in the federation among the multiple edge federation managers; and communicate the system data attributes, the authentication data attributes, the authorization data attributes, and the availability zone data attributes, via respective connections with the multiple edge federation managers.

In Example 2, the subject matter of Example 1 optionally includes wherein the edge computing system provides a first edge federation broker functionality for operating in a first region, and wherein the first edge federation broker functionality coordinates the partnership among the multiple edge federation managers.

In Example 3, the subject matter of Example 2 optionally includes the communications circuitry further configured to establish the respective connections with the multiple edge federation managers; wherein a dedicated interface is used to communicate between a first edge federation manager of the edge computing system and a second edge federation manager of a second edge computing system.

In Example 4, the subject matter of any one or more of Examples 2-3 optionally include the processing circuitry further configured to cause performance of an attestation-augmented authentication procedure among the multiple edge federation managers, based on authentication performed using the first edge federation broker functionality and a second edge federation broker functionality of a second edge computing system.

In Example 5, the subject matter of any one or more of Examples 1-4 optionally include the processing circuitry further configured to initiate computing operations in the federation with at least one of the multiple edge federation managers; wherein the respective connections include an east-westbound interface (EWBI) of the federation, the EWBI configured to perform information flows and coordinate the computing operations among the multiple edge federation managers.

In Example 6, the subject matter of any one or more of Examples 1-5 optionally include wherein the federation is established to join at least the edge computing system located at a first region with at least a second edge computing system located at a second region, and optionally wherein each region comprises a plurality of zones for operation of the federation, wherein the plurality of zones correspond to respective mobile network operators operating in each region.

In Example 7, the subject matter of any one or more of Examples 1-6 optionally include the processing circuitry further configured to: determine management and settlement information data attributes to enable management of resources in the federation among the multiple edge federation managers, in response to establishment of the federation of edge computing systems; and communicate the management and settlement data attributes, via the respective connections with the multiple edge federation managers.

In Example 8, the subject matter of Example 7 optionally includes the processing circuitry further configured to: manage operational properties in the federation using the management and settlement data attributes, wherein the management and settlement data attributes define the operational properties for at least one of: types of resources; amount of resources used; number of application instances; number of user sessions; usage time; or an identification of additional services.

In Example 9, the subject matter of any one or more of Examples 1-8 optionally include the processing circuitry further configured to: manage trustworthiness properties in the federation using the authentication data attributes, wherein the authentication data attributes define the trustworthiness properties for at least one of: the edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

In Example 10, the subject matter of any one or more of Examples 1-9 optionally include the processing circuitry further configured to: manage resource availability properties in the federation using the availability zone data attributes, wherein the availability zone data attributes define the resource availability properties for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.

In Example 11, the subject matter of any one or more of Examples 1-10 optionally include wherein the edge computing systems are respective multi-access edge computing (MEC) systems, wherein each of the MEC systems includes a plurality of MEC hosts, and wherein the federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host.

In Example 12, the subject matter of Example 11 optionally includes wherein the federation operates according to a European Telecommunications Standards Institute (ETSI) Multi-Access Edge Computing (MEC) specification.

Example 13 is a method performed at a computing node for performing edge federation management functions of edge computing systems, comprising: identifying system data attributes to establish a partnership among multiple edge federation managers as a federation of the edge computing systems; identifying authentication data attributes to enable the multiple edge federation managers to securely authenticate in the federation; identifying authorization data attributes to enable the multiple edge federation managers to perform authorization operations in the federation; identifying availability zone data attributes to define zones applicable in the federation among the multiple edge federation managers; and communicating the system data attributes, the authentication data attributes, the authorization data attributes, and the availability zone data attributes, via respective connections with the multiple edge federation managers.

In Example 14, the subject matter of Example 13 optionally includes wherein the method is performed by a first edge federation broker functionality of a first edge computing system for operating in a first region, and wherein the first edge federation broker functionality coordinates the partnership among the multiple edge federation managers.

In Example 15, the subject matter of Example 14 optionally includes establishing the respective connections with the multiple edge federation managers; wherein a dedicated interface is used to communicate between a first edge federation manager of the first edge computing system and a second edge federation manager of a second edge computing system.

In Example 16, the subject matter of any one or more of Examples 14-15 optionally include causing performance of an attestation-augmented authentication procedure among the multiple edge federation managers, based on authentication performed using the first edge federation broker functionality and a second edge federation broker functionality of a second edge computing system.

In Example 17, the subject matter of any one or more of Examples 13-16 optionally include initiating computing operations in the federation with at least one of the multiple edge federation managers; wherein the respective connections include an east-westbound interface (EWBI) of the federation, the EWBI configured to perform information flows and coordinate the computing operations among the multiple edge federation managers.

In Example 18, the subject matter of any one or more of Examples 13-17 optionally include wherein the federation is established to join at least a first edge computing system located at a first region with at least a second edge computing system located at a second region, and optionally, wherein each region comprises a plurality of zones for operation of the federation, wherein the plurality of zones correspond to respective mobile network operators operating in each region.

In Example 19, the subject matter of any one or more of Examples 13-18 optionally includes identifying management and settlement information data attributes to enable management of resources in the federation among the multiple edge federation managers, in response to establishment of the federation of edge computing systems; and communicating the management and settlement data attributes via respective connections with the multiple edge federation managers.

In Example 20, the subject matter of Example 19 optionally include managing operational properties in the federation using the management and settlement data attributes, wherein the management and settlement data attributes define the operational properties for at least one of: types of resources; amount of resources used; number of application instances; number of user sessions; usage time; or an identification of additional services.

In Example 21, the subject matter of any one or more of Examples 13-20 optionally include managing trustworthiness properties in the federation using the authentication data attributes, wherein the authentication data attributes define the trustworthiness properties for at least one of: an edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

In Example 22, the subject matter of any one or more of Examples 13-21 optionally include managing resource availability properties in the federation using the availability zone data attributes, wherein the availability zone data attributes define the resource availability properties for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.

In Example 23, the subject matter of any one or more of Examples 13-22 optionally include wherein the edge computing systems are respective multi-access edge computing (MEC) systems, wherein each of the MEC systems includes a plurality of MEC hosts, and wherein the federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host.

In Example 24, the subject matter of Example 23 optionally includes wherein the federation operates according to a European Telecommunications Standards Institute (ETSI) Multi-Access Edge Computing (MEC) specification.

Example 25 is at least one machine-readable storage medium comprising instructions stored thereupon, which when executed by processing circuitry of a computing machine, cause the processing circuitry to perform the edge federation management methods of any of Examples 12 to 24.

Example 26 is an edge computing system, comprising: an edge federator device, comprising: communication circuitry configured to communicate with multiple edge federation managers; processing circuitry configured to: identify system data attributes to establish a partnership among the multiple edge federation managers as a federation; identify authentication data attributes to enable the multiple edge federation managers to securely authenticate in the federation; identify authorization data attributes to enable the multiple edge federation managers to perform authorization operations in the federation; identify availability zone data attributes to define zones applicable in the federation among the multiple edge federation managers; identify management and settlement information data attributes to enable management of resources in the federation among the multiple edge federation managers; and cause the communication circuitry to communicate the system data attributes, the authentication data attributes, the authorization data attributes, the availability zone data attributes, and the management and settlement data attributes, via respective connections with the multiple edge federation managers.

In Example 27, the subject matter of Example 26 optionally includes at least one edge federation manager device, connected to the edge federator device via a defined interface in the edge computing system, the at least one edge federation manager device comprising processing circuitry configured to implement at least one of the multiple edge federation managers.

In Example 28, the subject matter of any one or more of Examples 26-27 optionally include an edge orchestrator device, connected to the edge federator device via a defined interface in the edge computing system, the edge orchestrator device comprising processing circuitry configured to orchestrate applications and services provided among at least one of the multiple edge federation managers.

In Example 29, the subject matter of any one or more of Examples 26-28 optionally include at least one edge computing host, each of the at least one edge computing host including: virtualization infrastructure; a data plane within the virtualization infrastructure; at least one edge computing platform; at least one edge computing platform service operated by the at least one edge computing platform; at least one edge computing application; and at least one edge computing service operated by at least one of the at least one edge computing application.

Example 30 is an apparatus for performing edge federation management functions, comprising: means for establishing system data attributes to establish a partnership among multiple edge federation entities as a federation; means for establishing authentication data attributes to enable the multiple edge federation entities to securely authenticate in the federation; means for establishing authorization data attributes to enable the multiple edge federation entities to perform authorization operations in the federation; means for establishing availability zone data attributes to define zones applicable in the federation; means for establishing management and settlement information data attributes to enable management of resources in the federation; and means for communicating the system data attributes, the authentication data attributes, the authorization data attributes, the availability zone data attributes, and the management and settlement data attributes.

In Example 31, the subject matter of Example 30 optionally includes means for establishing at least one federation agreement within the federation, the apparatus to operate in in an operational role as a first edge federation broker in a first region, wherein the first edge federation broker coordinates the partnership among the multiple edge federation entities.

In Example 32, the subject matter of Example 31 optionally includes means for establishing connections with the multiple edge federation entities, using respective interfaces; wherein the connections include use of an interface to communicate between a first edge federation manager and a second edge federation manager.

In Example 33, the subject matter of any one or more of Examples 31-32 optionally include means for performing an attestation-augmented authentication procedure among the multiple edge federation entities, based on authentication performed using the first edge federation broker and a second edge federation broker of a second edge computing system.

In Example 34, the subject matter of any one or more of Examples 30-33 optionally include means for enabling computing operations in the federation with at least one of the multiple edge federation managers, with use of an east-westbound interface (EWBI) of the federation, the EWBI configured to perform information flows and coordinate the computing operations among the multiple edge federation managers.

In Example 35, the subject matter of any one or more of Examples 30-34 optionally include means for enabling the federation to join at least a first edge computing system located at a first region with at least a second edge computing system located at a second region.

In Example 36, the subject matter of Example 35 optionally includes means for defining regions in the federation, wherein each region comprises a plurality of zones for operation of the federation, wherein the plurality of zones correspond to respective mobile network operators operating in each region.

In Example 37, the subject matter of any one or more of Examples 30-36 optionally include means for defining managing trustworthiness properties in the federation using the authentication data attributes, wherein the authentication data attributes define the trustworthiness properties for at least one of: an edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

In Example 38, the subject matter of any one or more of Examples 30-37 optionally include means for defining resource availability properties in the federation using the availability zone data attributes, wherein the availability zone data attributes define the resource availability properties for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.

In Example 39, the subject matter of any one or more of Examples 30-38 optionally include means for defining operational properties in the federation using the management and settlement data attributes, wherein the management and settlement data attributes define the operational properties for at least one of: types of resources; amount of resources used; number of application instances; number of user sessions; usage time; or an identification of additional services.

In Example 40, the subject matter of any one or more of Examples 30-39 optionally include wherein the federation comprises respective multi-access edge computing (MEC) systems, wherein each of the MEC systems includes a plurality of MEC hosts, and wherein the federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host.

In Example 41, the subject matter of any one or more of Examples 30-40 optionally include wherein the federation operates according to a European Telecommunications Standards Institute (ETSI) Multi-Access Edge Computing (MEC) specification.

Example 42 is at least one computer-readable storage medium comprising instructions stored thereupon, which when executed by circuitry of a computer, cause the circuitry to perform operations to: define system data attributes to establish a partnership among multiple edge federation managers as a federation of edge computing systems; define authentication data attributes to enable the multiple edge federation managers to securely authenticate in the federation; define authorization data attributes to enable the multiple edge federation managers to perform authorization operations in the federation; define availability zone data attributes to define zones applicable in the federation among the multiple edge federation managers; and communicate the system data attributes, the authentication data attributes, the authorization data attributes, and the availability zone data attributes, via respective connections with the multiple edge federation managers.

In Example 43, the subject matter of Example 42 optionally includes wherein the operations are performed by a first edge federation broker of a first edge computing system in a first region, and wherein the first edge federation broker coordinates the partnership among the multiple edge federation managers.

In Example 44, the subject matter of Example 43 optionally includes the instructions further to cause the circuitry to perform operations to: establish the respective connections with the multiple edge federation managers; wherein a first interface is used to communicate between the first edge federation broker and a first edge federation manager of the first edge computing system, and

wherein a second interface is used to communicate between the first edge federation broker and a second edge federation manager of a second edge computing system.

In Example 45, the subject matter of any one or more of Examples 43-44 optionally include the instructions further to cause the circuitry to perform operations to: cause performance of an attestation-augmented authentication procedure among the multiple edge federation managers, based on authentication performed using the first edge federation broker and a second edge federation broker of a second edge computing system.

In Example 46, the subject matter of any one or more of Examples 42-45 optionally include the instructions further to cause the circuitry to perform operations to: initiate computing operations in the federation with at least one of the multiple edge federation managers; wherein the respective connections include an east-westbound interface (EWBI) of the federation, the EWBI configured to perform information flows and coordinate the computing operations among the multiple edge federation managers.

In Example 47, the subject matter of any one or more of Examples 42-46 optionally include wherein the federation is established to join at least a first edge computing system located at a first region with at least a second edge computing system located at a second region, and optionally, wherein each region comprises a plurality of zones for operation of the federation, wherein the plurality of zones correspond to respective mobile network operators operating in each region.

In Example 48, the subject matter of any one or more of Examples 42-47 optionally include operations to determine management and settlement information data attributes to enable management of resources in the federation among the multiple edge federation managers, in response to establishment of the federation of edge computing systems; and communicate the management and settlement data attributes, via the respective connections with the multiple edge federation managers.

In Example 49, the subject matter of Example 48 optionally includes the instructions further to cause the circuitry to perform operations to: manage operational properties in the federation using the management and settlement data attributes, wherein the management and settlement data attributes define the operational properties for at least one of: types of resources; amount of resources used; number of application instances; number of user sessions; usage time; or an identification of additional services.

In Example 50, the subject matter of any one or more of Examples 42-49 optionally include the instructions further to cause the circuitry to perform operations to: manage trustworthiness properties in the federation using the authentication data attributes, wherein the authentication data attributes define the trustworthiness properties for at least one of: an edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

In Example 51, the subject matter of any one or more of Examples 42-50 optionally include the instructions further to cause the circuitry to perform operations to: manage resource availability properties in the federation using the availability zone data attributes, wherein the availability zone data attributes define the resource availability properties for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.

In Example 52, the subject matter of any one or more of Examples 42-51 optionally include wherein the edge computing systems are respective multi-access edge computing (MEC) systems, wherein each of the MEC systems includes a plurality of MEC hosts, and wherein the federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host.

In Example 53, the subject matter of Example 52 optionally includes wherein the federation operates according to a European Telecommunications Standards Institute (ETSI) Multi-Access Edge Computing (MEC) specification.

Example 54 is at least one machine-readable medium including instructions that, when executed by circuitry, cause the circuitry to perform operations to implement any of Examples 1-53.

Example 55 is an apparatus comprising means to implement any of Examples 1-54.

Example 56 is a system to implement any of Examples 1-54.

Example 57 is a method to implement any of Examples 1-54.

Example 58 is a multi-tier edge computing system, comprising a plurality of edge computing nodes provided among on-premise edge, network access edge, or near edge computing settings, the plurality of edge computing nodes configured to implement any of Examples 1-54.

Example 59 is an edge computing node, operable in a layer of an edge computing network as an aggregation node, network hub node, gateway node, or core data processing node, configured to implement any of Examples 1-54.

Example 60 is an edge computing network, comprising networking and processing components configured to provide or operate a communications network, to enable an edge computing system to implement any of Examples 1-54.

Example 61 is an edge computing system configured as an edge mesh, provided with a microservice cluster, a microservice cluster with sidecars, or linked microservice clusters with sidecars, configured to implement any of Examples 1-54.

Example 62 is an edge computing system, comprising circuitry configured to implement services with one or more isolation environments provided among dedicated hardware, virtual machines, containers, or virtual machines on containers, the edge computing system configured to implement any of Examples 1-54.

Example 63 is an edge computing system, comprising networking and processing components to communicate with a user equipment device, client computing device, provisioning device, or management device to implement any of Examples 1-54.

Example 64 is networking hardware with network functions implemented thereupon, operable within an edge computing system, the network functions configured to implement any of Examples 1-5444.

Example 65 is storage hardware with storage capabilities implemented thereupon, operable in an edge computing system, the storage hardware configured to implement any of Examples 1-54.

Example 66 is computation hardware with compute capabilities implemented thereupon, operable in an edge computing system, the computation hardware configured to implement any of Examples 1-54.

Example 67 is a computer program used in an edge computing system, the computer program comprising instructions, wherein execution of the program by a processing element in the edge computing system is to cause the processing element to implement any of Examples 1-54.

Example 68 is an edge computing appliance device operating as a self-contained processing system, comprising a housing, case, or shell, network communication circuitry, storage memory circuitry, and processor circuitry adapted to implement any of Examples 1-54.

Example 69 is an apparatus of an edge computing system comprising means to implement any of Examples 1-54.

Example 70 is an apparatus of an edge computing system comprising logic, modules, or circuitry to implement any of Examples 1-54.

Example 71 is an edge computing system, including respective edge processing devices and nodes to invoke or perform any of the operations of Examples 1-54, or other subject matter described herein.

Example 72 is an edge node operating an edge provisioning service, application or service orchestration service, virtual machine deployment, container deployment, function deployment, and compute management, within or coupled to an edge computing system, operable to invoke or perform the operations of any of Examples 1-54, or other subject matter described herein.

Example 73 is an edge computing system including aspects of network functions, acceleration functions, acceleration hardware, storage hardware, or computation hardware resources, operable to invoke or perform the use cases discussed herein, with use of any Examples 1-54, or other subject matter described herein.

Example 74 is an edge computing system adapted for supporting client mobility, vehicle-to-vehicle (V2V), vehicle-to-everything (V2X), or vehicle-to-infrastructure (V2I) scenarios, operable to invoke or perform the use cases discussed herein, with use of any of Examples 1-54, or other subject matter described herein.

Example 75 is an edge computing system adapted for mobile wireless communications, including configurations according to a 3GPP 4G/LTE or 5G network capabilities, operable to invoke or perform the use cases discussed herein, with use of any of Examples 1-54, or other subject matter described herein.

Example 76 is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of any of Examples 1-54, or other subject matter described herein.

Example 77 is networking hardware, acceleration hardware, storage hardware, or computation hardware, with capabilities implemented thereupon, operable in an edge computing system to invoke or perform the use cases discussed herein, with use of any of Examples 1-54, or other subject matter described herein.

Example 78 is an apparatus of an edge computing system comprising: one or more processors and one or more computer-readable media comprising instructions that, when deployed and executed by the one or more processors, cause the one or more processors to invoke or perform the use cases discussed herein, with use of any of Examples 1-54, or other subject matter described herein.

Example 79 is one or more computer-readable storage media comprising instructions to cause an electronic device of an edge computing system, upon execution of the instructions by one or more processors of the electronic device, to invoke or perform the use cases discussed herein, with the use of any of Examples 1-54, or other subject matter described herein.

Example 80 is an apparatus of an edge computing system comprising means, logic, modules, or circuitry to invoke or perform the use cases discussed herein, with the use of any of Examples 1-54, or other subject matter described herein.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

1.-30. (canceled)

31. An edge computing system to enable edge federation management in an edge computing network, comprising:
communications circuitry configured to communicate with a plurality of federation managers, the plurality of federation managers located at multiple computing nodes in the edge computing network; and
processing circuitry configured to:
identify system data attributes to establish a partnership among multiple edge federation managers as a federation of edge computing systems;
identify authentication data attributes to enable the multiple edge federation managers to securely authenticate in the federation;
identify authorization data attributes to enable the multiple edge federation managers to perform authorization operations in the federation;
identify availability zone data attributes to define zones applicable in the federation among the multiple edge federation managers; and
communicate the system data attributes, the authentication data attributes, the authorization data attributes, and the availability zone data attributes, via respective connections with the multiple edge federation managers.

32. The edge computing system of claim 31, wherein the edge computing system provides a first edge federation broker functionality for operating in a first region, and wherein the first edge federation broker functionality coordinates the partnership among the multiple edge federation managers.

33. The edge computing system of claim 32, wherein the communications circuitry is configured to cause the respective connections with the multiple edge federation managers to be established;
wherein a dedicated interface is used to communicate between a first edge federation manager of the edge computing system and a second edge federation manager of a second edge computing system.

34. The edge computing system of claim 32, wherein the processing circuitry is configured to cause performance of an attestation-augmented authentication procedure among the multiple edge federation managers, based on authentication performed using the first edge federation broker functionality and a second edge federation broker functionality of a second edge computing system.

35. The edge computing system of claim 31, wherein the processing circuitry is configured to initiate computing operations in the federation with at least one of the multiple edge federation managers;
wherein the respective connections include an east-westbound interface (EWBI) of the federation, the EWBI configured to perform information flows and coordinate the computing operations among the multiple edge federation managers.

36. The edge computing system of claim 31, wherein the federation is established to join at least the edge computing system located at a first region with at least a second edge computing system located at a second region, and
wherein each region comprises a plurality of zones for operation of the federation, wherein the plurality of zones correspond to respective mobile network operators operating in each region.

37. The edge computing system of claim 31, wherein the processing circuitry is configured to:
determine management and settlement information data attributes to enable management of resources in the federation among the multiple edge federation managers, in response to establishment of the federation of edge computing systems;
manage operational properties in the federation using the management and settlement data attributes, wherein the management and settlement data attributes define the operational properties for at least one of: types of resources; amount of resources used; number of application instances; number of user sessions; usage time; or an identification of additional services; and
communicate the management and settlement data attributes, via the respective connections with the multiple edge federation managers.

38. The edge computing system of claim 31, wherein the processing circuitry is configured to:
manage trustworthiness properties in the federation using the authentication data attributes, wherein the authentication data attributes define the trustworthiness properties for at least one of: the edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

39. The edge computing system of claim 31, wherein the processing circuitry is configured to:
manage resource availability properties in the federation using the availability zone data attributes, wherein the availability zone data attributes define the resource availability properties for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.

40. The edge computing system of claim 31, wherein the edge computing systems are respective multi-access edge computing (MEC) systems,
wherein each of the MEC systems includes a plurality of MEC hosts, and
wherein the federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host;
wherein the federation operates according to a European Telecommunications Standards Institute (ETSI) Multi-Access Edge Computing (MEC) specification.

41. A method performed at a computing node for edge federation management of edge computing systems, comprising:
identifying system data attributes to establish a partnership among multiple edge federation managers as a federation of the edge computing systems;
identifying authentication data attributes to enable the multiple edge federation managers to securely authenticate in the federation;
identifying authorization data attributes to enable the multiple edge federation managers to perform authorization operations in the federation;
identifying availability zone data attributes to define zones applicable in the federation among the multiple edge federation managers; and
communicating the system data attributes, the authentication data attributes, the authorization data attributes, and the availability zone data attributes, via respective connections with the multiple edge federation managers.

42. The method of claim 41, wherein the method is performed by a first edge federation broker functionality of a first edge computing system for operating in a first region, and wherein the first edge federation broker functionality coordinates the partnership among the multiple edge federation managers.

43. The method of claim 42, further comprising:
establishing the respective connections with the multiple edge federation managers;
wherein a dedicated interface is used to communicate between a first edge federation manager of the first edge computing system and a second edge federation manager of a second edge computing system.

44. The method of claim 42, further comprising:
causing performance of an attestation-augmented authentication procedure among the multiple edge federation managers, based on authentication performed using the first edge federation broker functionality and a second edge federation broker functionality of a second edge computing system.

45. The method of claim 41, further comprising:
initiating computing operations in the federation with at least one of the multiple edge federation managers;
wherein the respective connections include an east-westbound interface (EWBI) of the federation, the EWBI configured to perform information flows and coordinate the computing operations among the multiple edge federation managers.

46. The method of claim 41, wherein the federation is established to join at least a first edge computing system located at a first region with at least a second edge computing system located at a second region, and wherein each region comprises a plurality of zones for operation of the federation, wherein the plurality of zones correspond to respective mobile network operators operating in each region.

47. The method of claim 41, further comprising:
identifying management and settlement information data attributes to enable management of resources in the federation among the multiple edge federation managers, in response to establishment of the federation of edge computing systems;
managing operational properties in the federation using the management and settlement data attributes, wherein the management and settlement data attributes define the operational properties for at least one of: types of resources; amount of resources used; number of application instances; number of user sessions; usage time; or an identification of additional services; and
communicating the management and settlement data attributes via respective connections with the multiple edge federation managers.

48. At least one non-transitory machine-readable storage medium comprising instructions stored thereupon, which when executed by processing circuitry of a computing machine, cause the processing circuitry to perform edge federation management operations that:
identify system data attributes to establish a partnership among multiple edge federation managers as a federation of the edge computing systems;
identify authentication data attributes to enable the multiple edge federation managers to securely authenticate in the federation;
identify authorization data attributes to enable the multiple edge federation managers to perform authorization operations in the federation;
identify availability zone data attributes to define zones applicable in the federation among the multiple edge federation managers; and
communicate the system data attributes, the authentication data attributes, the authorization data attributes, and the availability zone data attributes, via respective connections with the multiple edge federation managers;
wherein the edge computing systems are respective multi-access edge computing (MEC) systems,
wherein each of the MEC systems includes a plurality of MEC hosts, and
wherein the federation operates to manage compute operations in the plurality of MEC hosts, with management of at least one of: MEC applications, MEC services within a MEC application, MEC services within a MEC platform, a data plane within a respective MEC host, or a virtualization infrastructure within a respective MEC host.

49. The machine-readable storage medium of claim 48, wherein the instructions further cause the processing circuitry to:
manage trustworthiness properties in the federation using the authentication data attributes, wherein the authentication data attributes define the trustworthiness properties for at least one of: the edge computing system, hosts or cloudlets of the edge computing system, a platform of the edge computing system, an application programming interface of the edge computing system, an instantiated application of the edge computing system, a data plane of a host or cloudlet of the edge computing system, a virtualized infrastructure of a host or cloudlet of the edge computing system, a processing unit of a host or cloudlet of the edge computing system, a storage unit of a host or cloudlet of the edge computing system, or a connectivity unit of a host or cloudlet of the edge computing system.

50. The machine-readable storage medium of claim 48, wherein the instructions further cause the processing circuitry to:
manage resource availability properties in the federation using the availability zone data attributes, wherein the availability zone data attributes define the resource availability properties for at least one of: offered central processing unit (CPU) resources; offered memory resources; offered storage resources; offered specialized computing resources; offered graphic processing unit resources; offered vision processing unit resources; offered neural processing unit resources; or offered field-programmable gate array (FPGA) resources.
